(19) United States
(12) Patent Application Publication
(10) Pub. No.: US 2020/0221179 A1
(43) Pub. Date: Jul. 9, 2020

(54) METHOD OF PROVIDING RECOMMENDATION LIST AND DISPLAY DEVICE USING THE SAME

(71) Applicant: SAMSUNG ELECTRONICS CO., LTD., Suwon-si (KR)

(72) Inventors: Sungwon KIM, Suwon-si (KR); Dosung KIM, Suwon-si (KR); Injune BAEK, Suwon-si (KR); Youngjoon YOO, Suwon-si (KR); Bongseok LEE, Suwon-si (KR)

(21) Appl. No.: 16/735,971

(22) Filed: Jan. 7, 2020

(30) Foreign Application Priority Data
Jan. 7, 2019 (KR) 10-2019-0001927

(51) Int. Cl. H04N 21/466; H04N 21/45; H04N 21/2668

(52) U.S. Cl. CPC H04N 21/4666; H04N 21/2668; H04N 21/4532

(57) ABSTRACT

Provided is a method, performed by a display device for outputting content, of providing a recommendation list, the method including generating viewing history information by applying a first weight to a first content displayed without user input for content selection, the first weight having a value less than a value of a weight applied to a second content, the second content being displayed through a user input for content selection, and generating a recommendation list comprising at least one recommendation item based on the viewing history information.

### CROSS-REFERENCE TO RELATED APPLICATION

This application is based on and claims priority under 35 U.S.C. § 119 to Korean Patent Application No. 10-2019-0001927, filed on Jan. 7, 2019, in the Korean Intellectual Property Office, the disclosure of which is incorporated by reference herein in its entirety.

### BACKGROUND

### 1. Field

The disclosure relates to a method of providing a recommendation list and a display device using the method.

For example, the disclosure relates to a method of providing a recommendation list to increase user satisfaction based on a viewing history of a user with respect to a display device, and the display device using the method.

### 2. Description of Related Art

With the distribution of displays and the development of technologies, display devices having various forms and functions have been developed.

Accordingly, functions meeting various needs or intentions of consumers may be implemented using a display device.

The display device may be connected to various wired or wireless communication networks and receive at least one of a plurality of content through the connected communication network. In recent years, the types and number of content that may be displayed through the display device have become very diverse. Specifically, the display device may receive and display at least one of a plurality of items of content transmitted from each of channels corresponding to a plurality of broadcasting stations through a communicator included therein. In addition, the display device may access at least one server through the Internet, and receive and display at least one content from the at least one connected server. In addition, the display device may select at least one of many various kinds of content from an external device connected through various wired and wireless networks, for example, a broadcasting station server, an Internet server, a content server, a content providing device, or a content storage device.

As described above, because the types and number of content that the display device may selectively receive and display increase, a user may experience inconvenience in selecting any one of numerous items of content.

Accordingly, it is necessary to generate and provide a content recommendation list such that the user who views certain content through the display device may quickly select desired content.

### SUMMARY

Embodiments of the disclosure provide a method of providing a recommendation list such that a user may quickly and conveniently select desired content, and a display device using the method.

Embodiments of the disclosure provide a method of providing a recommendation list by generating the recommendation list in consideration of whether a user input for selecting content exists such that a user may quickly and conveniently select desired content, and a display device using the method.

Additional aspects will be set forth in part in the description which follows and, in part, will be apparent from the description.

According to an example embodiment of the disclosure, a method, performed by a display device for outputting content, of providing a recommendation list includes generating viewing history information by applying a first weight to first content displayed without user input for content selection, the first weight having a value less than a value of a weight applied to a second content, the second content being content displayed based on a user input for content selection; generating a recommendation list including at least one recommendation item based on the viewing history information; and providing the recommendation list to a user. In the above-described example embodiment of the disclosure, a viewing history may be obtained by applying a relatively high weight to content that a user actively searches for and views, thereby generating the recommendation list that further corresponds to the intention of the user. Accordingly, a recommendation channel that further corresponds to the intention of the user may be obtained, and the satisfaction of the user who receives the recommendation list may increase.

The first content may be displayed on the display device without a user input for selecting the first content (e.g., not based on a user selection for the content).

The second content may be displayed on the display device by receiving a user input for selecting the second content (e.g., based on a user selection for the content).

The method may further include setting a value of a weight applied to the second content differently based on a type of the user input for selecting the second content. In the above-described example embodiment of the disclosure, the viewing history information may be obtained by applying different weights based on the aggressiveness of the user for selecting content in consideration of a type of a user input. Accordingly, in an example embodiment of the disclosure, a degree of contribution of viewing history may be subdivided based on a plurality of types of user inputs. Accordingly, in an example embodiment of the disclosure, the viewing history information more accurately reflecting the aggressiveness of the user may be obtained.

The generating of the viewing history information may include obtaining the viewing history information by applying a second weight to the second content, based on the second content being selected through a first type of selection method, applying a third weight to the second content based on the second content being selected through a second type of selection method, and applying a fourth weight to the second content based on the second content being selected through a third type of selection method.

The first type of selection method may be a selection method of directly referring to the second content, the second type of selection method may be a selection method of referring to a channel providing the second content, and the third type of selection method may be a selection method using a channel up key or a channel down key for selecting the second content.

According to the above-described example embodiment of the disclosure, when a user enters an input directly referring to content to a display device, the viewing history information may be obtained by applying a largest weight, and thus the recommendation channel may be generated by preferentially considering content that the user most actively views.

The method may further include obtaining the first weight and the weight applied to the second content through an operation using a neural network. The neural network may be configured to receive a viewing history indicating a plurality of content output through the display device during a first period and information about a user input for selecting the plurality of content during the first period, perform an operation using at least one layer of the neural network, and output a value of the first weight applied to the first content and a value of at least one weight applied to the second content. In the above-described example embodiment of the disclosure, weight values may be obtained through the neural network such that a predicted recommendation channel further corresponds to an actual viewing history of the user.

The information about the user input may include a type of the user input for selecting content and time information corresponding to the user input.

The generating of the viewing history information may include obtaining the viewing history information based on metadata indicating an output schedule of the content output from a set top box based on the display device outputting content provided through the set top box. In the above-described example embodiment of the disclosure, the viewing history information may be obtained using the metadata received through the set-top box, and thus channel and genre information about the content viewed by the user may be obtained quickly and easily.

The providing may include obtaining the at least one recommendation item by performing an operation using a neural network that receives the viewing history information obtained by applying at least one of the first weight applied to the first content or the weight applied to the second content.

The method may further include transmitting the viewing history information to a server providing a service customized for each individual. According to the above-described embodiment of the disclosure, the viewing history information indicating the aggressiveness of the user who views selectively content may be provided to a server providing a service customized for each individual Accordingly, an external server may provide a service improved for the tendency of the user of the display device and increase the user's satisfaction of the display device receiving the service.

According to another example embodiment of the disclosure, a display device includes a display; a user interface comprising circuitry configured to receive a user input; a memory storing one or more instructions; and a controller including at least one processor configured to execute at least one of the one or more instructions. The controller may be further configured to, by executing at least one of the one or more instructions, control the device to: generate viewing history information by applying a first weight to first content displayed without a user input for content selection, the first weight having a value less than a value of a weight applied to a second content, the second content being content displayed based on a user input for content selection; generate a recommendation list including at least one recommendation item based on the viewing history information; and display a screen including the recommendation list.

### BRIEF DESCRIPTION OF THE DRAWINGS

The above and other aspects, features, and advantages of certain embodiments of the disclosure will be more apparent from the following detailed description, taken in conjunction with the accompanying drawings, in which:

FIG. 1 is a diagram illustrating an example display device for providing a channel recommendation list according to an embodiment of the disclosure;

FIG. 2 is a block diagram illustrating an example display device according to an embodiment of the disclosure;

FIG. 3 is a block diagram illustrating an example display device according to another embodiment of the disclosure;

FIG. 4 is a block diagram illustrating an example display device according to another embodiment of the disclosure;

FIG. 5 is a diagram illustrating an example display device according to another embodiment of the disclosure;

FIG. 6 is a block diagram illustrating the display device illustrated in FIG. 5 according to an embodiment of the disclosure;

FIG. 7 is a flowchart illustrating an example method of providing a recommendation list according to an embodiment of the disclosure;

FIG. 8 is a diagram illustrating example information representing a viewing history of a user, according an embodiment of the disclosure;

FIG. 9 is a diagram for illustrating an example user input entered for selecting content according to an embodiment of the disclosure;

FIG. 10 is a diagram illustrating an example weight applied to various content according to an embodiment of the disclosure;

FIG. 11 is a diagram illustrating an example operation of updating the weight according to an embodiment of the disclosure;

FIG. 12 is a diagram illustrating an example weight applied to various content according to another embodiment of the disclosure;

FIG. 13 is a diagram illustrating an example operation of updating the weight according to another embodiment of the disclosure;

FIG. 14 is a diagram illustrating an example neural network used to obtain recommended channels, according to an embodiment of the disclosure;

FIG. 15 is a diagram illustrating an example neural network used to obtain recommendation channels, according to an embodiment of the disclosure;

FIG. 16 is a diagram illustrating example input data input to the neural network shown in FIG. 15 according to an embodiment of the disclosure; and

FIG. 17 is a diagram illustrating example viewing history obtained according to an embodiment of the disclosure.

### DETAILED DESCRIPTION

Hereinafter, the disclosure will be described in greater detail by illustrating various example embodiments of the disclosure with reference to the attached drawings. The disclosure may, however, be embodied in many different forms and should not be understood as being limited to the example embodiments of the disclosure set forth herein. In the drawings, parts not related to the disclosure may not be illustrated for clarity of explanation, and like reference numerals denote like elements.

It will be understood that when an element is referred to as being “connected to” another element, it may be “directly connected to” the other element or be “electrically connected to” the other element through an intervening element. It will be further understood that the terms “includes” and/or “including”, when used herein, specify the presence of stated elements, but do not preclude the presence or addition of one or more other elements, unless the context clearly indicates otherwise.

Herein, expressions such as “some embodiments of the disclosure” and “an embodiment of the disclosure” do not always designate the same embodiment(s) of the disclosure.

Some embodiments of the disclosure may be described in terms of functional blocks and various processing steps. Some or all of the functional blocks may be implemented by any number of hardware and/or software elements configured to perform certain functions. For example, the functional blocks of the disclosure may be implemented by one or more processors or microprocessors, or circuit elements for certain functions. As another example, the functional blocks of the disclosure may be implemented using any programming or scripting language. The functional blocks may be implemented using various algorithms executed by the one or more processor. Furthermore, the disclosure might employ known technologies for electronic settings, signal processing, and/or data processing. Terms such as “module”, “element”, etc. may be widely used and are not limited to mechanical and physical elements.

In addition, connection lines or connection members between elements shown in the drawings illustrate functional connections and/or physical or circuit connections. Connections between elements may be represented by replaceable or additional various functional connections, physical connections, or circuit connections in an actual apparatus.

Throughout the disclosure, the expression “at least one of a, b or c” indicates only a, only b, only c, both a and b, both a and c, both b and c, all of a, b, and c, or variations thereof.

Reference will now be made in detail to various example embodiments of the disclosure, examples of which are illustrated in the accompanying drawings.

A display device according to an embodiment of the disclosure may include all electronic devices for visually outputting certain contents. For example, the display device according to an embodiment of the disclosure includes all electronic devices capable of selectively displaying at least one content, and may be provided in various forms, e.g., a television (TV), a digital broadcast receiver, a tablet personal computer (PC), a smart phone, mobile phone, a computer, a laptop computer, or the like, but is not limited thereto. The display device may be not only stationary but also portable or carriable by a user.

The display device according to an embodiment of the disclosure may display a recommendation list including channels that a user prefers or is likely to view on a screen based on the viewing history of the user. Accordingly, the display device may allow the user to quickly and conveniently select and view a desired channel among numerous channels. The recommendation list provided in an embodiment of the disclosure may include at least one recommendation item. The recommendation item may include at least one of a channel number to be recommended to the user, an identification mark indicating a channel, a channel name, or a content name (or a program name).

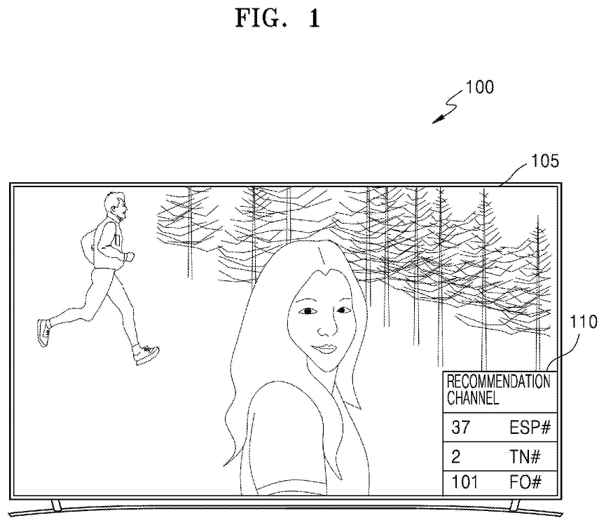

FIG. 1 is a diagram illustrating an example display device 100 for providing a channel recommendation list 110 according to an embodiment of the disclosure.

The display device 100 may output the recommendation list 110 on a screen 105. The recommendation list 110 may be generated through various selection methods and analysis methods.

For example, the display device 100 may analyze the viewing history of a user, extract channels having a high frequency of viewing of the user, and generate the recommendation list 110 using the extracted channels. Accordingly, the recommendation list 110 may be a channel list including channels that the user frequently viewed using the viewing history of the user. The viewing history may, for example, include a record by the user who uses the display device 100 for a certain period with respect to content or a channel displayed on the display device 100, and may include information about a channel matching at least one of the day of week, date or time.

For example, the display device 100 may be a TV. However, it will be understood that the disclosure is not limited thereto.

The user may turn on the display device 100 to view a certain content (e.g., news transmitted through a specific channel, etc.) at 8 pm Thursday. The display device 100 may output the recommendation list 110 immediately after turned on.

In general, the viewing history may be ‘viewing channel information by hour of day’ which may include information about channels that the user has viewed through the display device 100 for each hour of day. When the recommendation list 110 is generated based on the viewing channel information by hour of day, it may be effective to inform a channel preferred by the user at a specific time. However, the viewing channel information by hour of day does not include information about whether the channel viewed by the user is a channel that the user actively wanted to view or is simply output when the display device 100 is turned on.

Therefore, in order to recommend the channel or content desired by the user, it may be necessary to consider whether the user has selected content included in the viewing history in obtaining the viewing history. In other words, when the viewing history is obtained considering whether the user has actively selected the content included in the viewing history, the recommendation list 110 more closely matching the intention of the user may be obtained.

In an embodiment of the disclosure, the viewing history may be obtained by applying different weights to various content based on whether the channel or the content included in the viewing history includes a user input for selecting the content. Accordingly, in an embodiment of the disclosure, the content desired by the user may be more accurately obtained through a recommendation channel (or a recommendation program), and accordingly the satisfaction of the user provided with the recommendation list 110 may increase.

A more detailed configuration and operation of a method of providing a recommendation list and a display device using the method according to an embodiment of the disclosure will be described in greater detail below with reference to the accompanying drawings.

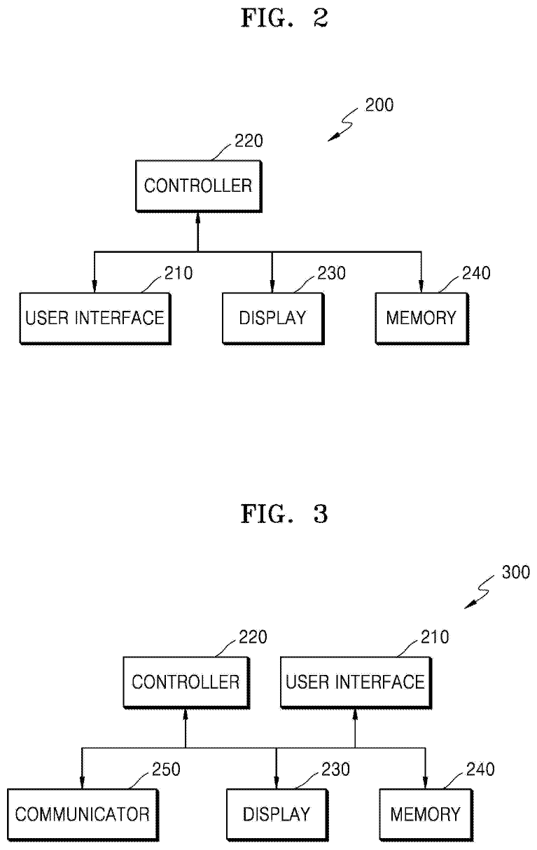

FIG. 2 is a block diagram illustrating an example display device 200 according to an embodiment of the disclosure.

Referring to FIG. 2, the display device 200 according to an embodiment of the disclosure may include a user interface (e.g., including interface circuitry) 210, a controller (e.g., including processing circuitry) 220, a display 230, and a memory 240.

The user interface 210 may include various interface circuitry and receive a user input. For example, the user interface 210 may receive the user input for content selection. In an embodiment of the disclosure, the “user input for content selection” may refer to all user inputs used to select content to be viewed when a user views the content output from the display device 200. For example, the user may enter a user input corresponding to the name of the content so as to select the content to view, and select the content to be viewed by operating a channel up key or a channel down key of a remote controller (not shown).

The memory 240 stores at least one instruction. In addition, the memory 240 may store content to be output through the display 230. For example, the memory 240 may include a buffer memory that buffers and stores the content to be output through the display 230.

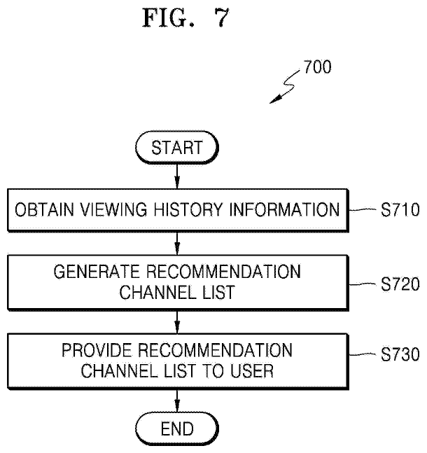

The controller 220 may include various processing circuitry, including, for example, at least one processor (not shown) that executes the at least one instruction. For example, the controller 220 may execute the at least one instruction to control a certain operation to be performed. For example, the controller 220 may generate viewing history information by applying a first weight having a smaller value than that of a weight applied to a second content to a first content, the second content being content displayed based on the user input for content selection and the first content being a content displayed without the user input for content selection (see, e.g., S710 in FIG. 7). The controller 220 may generate a recommendation list including at least one recommendation channel based on the generated viewing history information (see, e.g., S720 in FIG. 7) and control a screen including the recommendation list to be displayed(see, e.g., S720 in FIG. 7).

For example, the “first content” may refer to content in which a user input for selecting the content among contents output by the display device 200 does not exist. For example, the first content may refer to content displayed on the display device 200 without the user input for selecting the content. The “second content” may refer to content in which the user input for selecting the content among the contents output by the display device 200 exists. For example, the second content may refer to content displayed on the display device 200 corresponding to receiving the user input for selecting the content. For example, the first content and the second content do not refer to specific content, but are distinguished based on whether a user input for the content exists.

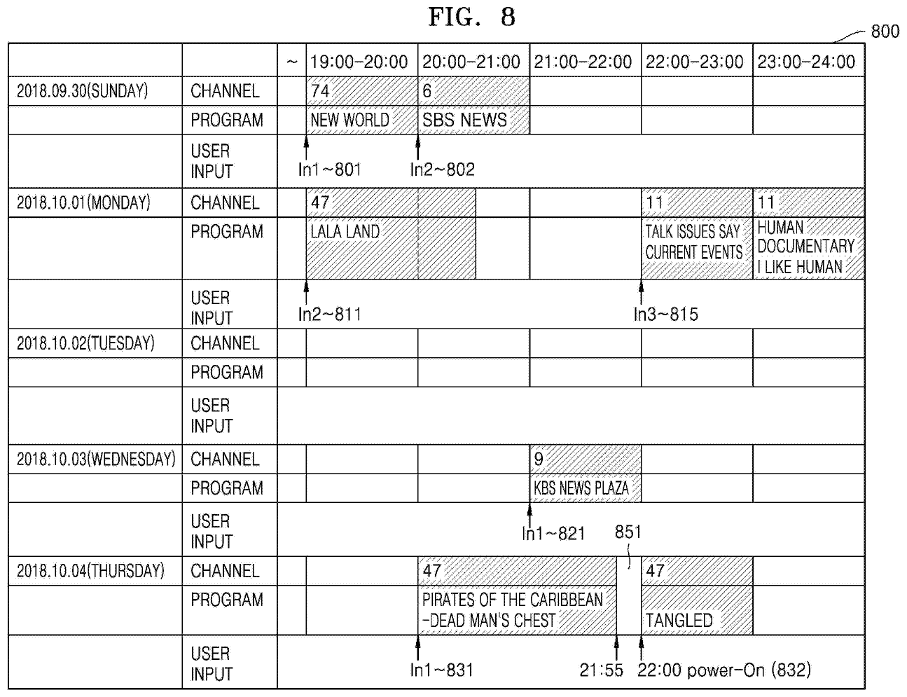

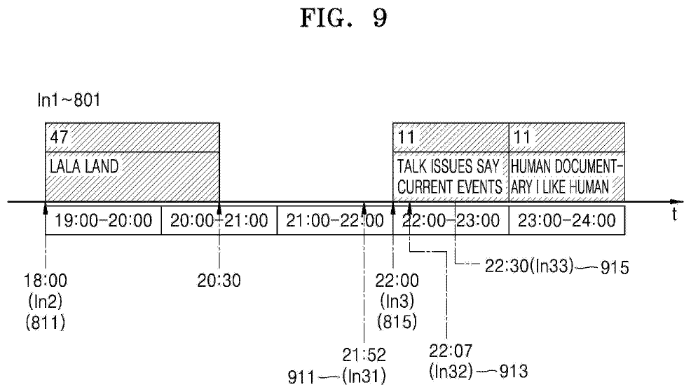

In addition, whether the user input for selecting the content exists may be determined based on information (e.g., EPG, metadata, etc.) indicating an output schedule of the content. For example, when the user input for selecting the content is received at a time when the content is being reproduced or at a time within a certain time when the content starts, it may be determined that the user input for selecting the content exists. Whether the user input exists will be described in greater detail below with reference to FIGS. 8 and 9.

The recommendation list may include at least one recommendation item. In addition, the ‘recommended item’ may include at least one of a channel or a name of content provided through the channel. For example, the recommended item may include at least one of a channel number to be recommended to the user, an identification mark indicating the channel, a channel name, or a content name (or a program name).

In addition, the content name may refer, for example, to the name of a broadcast program. For example, when the content is a movie, the content name may be the title of the movie, and when the content is a miniseries of a broadcasting station, the content name may be the title of the miniseries.

Hereinafter, the display device 200 will be described in greater detail.

The user interface 210 may include various interface circuitry and receive a user input for controlling the display device 200. For example, the user interface 210 may be a component for interacting with the user and may include an input device (not shown) for receiving the user input.

For example, the user interface 210 may include, for example, and without limitation, a user input device including a touch panel that senses a touch of the user, a button that receives the push operation of the user, a wheel that receives the rotation operation of the user, a keyboard, a dome switch, etc., but is not limited thereto. In addition, when the display device 200 operates by a remote controller (not shown), the user interface 210 may receive a control signal received from the remote controller (not shown).

In an embodiment of the disclosure, when receiving the user input, the user interface 210 may transmit the user input to the controller 220. For example, the user input may correspond to a certain event. The certain event may be an event for searching for a channel or content, an event for selecting the channel or the content, an event for turning on the display device 200, an event for changing a channel output by the display device 200, an event for activating a channel recommendation function of the display device 200, an event for requesting the display device 200 to output a channel recommendation list, etc.

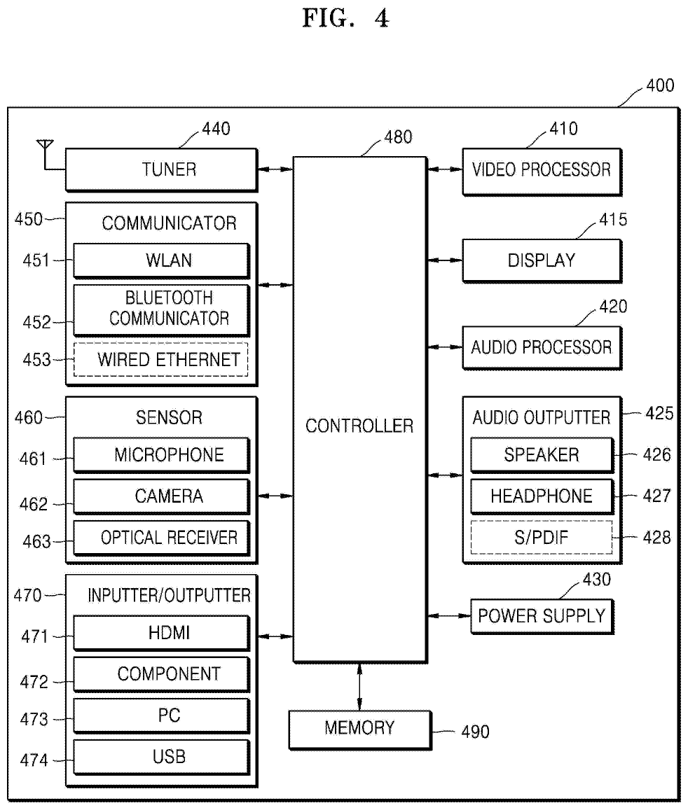

In an embodiment of the disclosure, the display device 200 may further include a sensor (not shown) (e.g., corresponding to 460 of FIG. 4). The sensor (not shown) may sense voice of the user, an image of the user, or an interaction of the user. For example, the sensor (not shown) may sense an interaction for searching for a channel or content, an interaction for selecting the channel or the content, an interaction for changing a channel output by the display device 200, an interaction for activating a channel recommendation function of the display device 200, an interaction for requesting the display device 200 to output a channel recommendation list, etc. In addition, the sensor (not shown) may transmit the sensed interaction to the controller 220. Then, the controller 220 may determine that a certain event has occurred based on a sensing result of the sensor (not shown).

In addition, the sensor (not shown) may be included in the user interface 210. For example, the sensor (not shown) may be a component that performs an operation of sensing or receiving a user input and may serve as the user interface 210. In view of receiving or sensing the user input, the sensor (not shown) may be a component required for receiving the user input in the same manner as the user interface 210. However, a module or a sensor for sensing the user input included in the sensor (not shown) may be physically distinguished from a communication module (not shown) for receiving a control signal from the above-described touch panel, button, wheel, keyboard, and remote controller (not shown) included in the user interface 210.

For example, the sensor (not shown) may sense the user input and transmit a sensing result of the user input to the user interface 210. Then, the user interface 210 or the controller 220 may obtain the user input based on the sensing result obtained through the sensor (not shown) included therein. The user input sensed by the sensor (not shown) will be described in greater detail below with reference to FIG. 8.

The memory 240 may store one or more instructions.

In addition, the memory 240 may store information including viewing time, channel, and genre information of content viewed by the user for a certain period under the control of the controller 220. For example, the controller 220 may obtain information about a history of content output by the display device 200 (or viewed by the user) for the certain period and store the information in the memory 240.

In addition, the viewing history information stored in the memory 240 may be continuously updated and stored as time passes. For example, the controller 220 may update the viewing history information for every certain time period or for every time the user input occurs such that the viewing history of the user for a previous certain time interval with respect to a current time is stored in the memory 240. Alternatively, the controller 220 may update the viewing history information whenever the viewing history of the user occurs.

In addition, the viewing history information of the user may be reflected and updated as the viewing history of the user only when content viewing is performed for a certain time or more. For example, when the user views a certain channel for a short time, for example, 5 minutes or less or 10 minutes or less, it may not be regarded that the user has viewed the certain channel meaningfully. Therefore, when the viewing time of the user is a certain time, for example, 10 minutes or more or 20 minutes or more, the viewing history information of the user may be reflected as the viewing history of the user.

In addition, the memory 240 may include at least one of flash memory, a hard disk, a multimedia card micro, card-type memory (e.g., secure digital (SD) or extreme digital (XD) memory), random access memory (RAM), static RAM (SRAM), read-only memory (ROM), electrically erasable programmable ROM (EEPROM), programmable ROM (PROM), magnetic memory, a magnetic disc, or an optical disc.

The controller 220 may include various processing circuitry, including, for example, at least one processor (not shown) configured to execute one or more instructions. Each of the at least one processor may perform a certain operation by executing at least one of one or more instructions stored in the memory 240.

Each of the at least one processor may perform a certain operation by executing at least one of one or more instructions stored in the controller 220.

The at least one processor included in the controller 220 may control operations performed by the display device 200, or control the other elements included in the display device 200, to perform a certain operation. Therefore, although it is described below that the controller 220 controls certain operations to be performed, it will be easily understood that the at least one processor included in the controller 220 may control the certain operations to be performed.

In addition, the controller 220 may include an internal memory (not shown) and at least one processor (not shown) configured to execute at least one program stored in the internal memory. For example, the internal memory of the controller 220 may store one or more instructions. The at least one processor included in the controller 220 may perform a certain operation by executing at least one of the one or more instructions stored in the internal memory of the controller 220.

For example, the controller 220 may include random access memory (RAM) (not shown) storing signals or data input from outside the display device 200 or used as a storage area for various operations performed by the display device 200, read-only memory (ROM) (not shown) storing a plurality of instructions and/or a control program for controlling the display device 200, and at least one processor (not shown). The processor may include a graphic processing unit (GPU) (not shown) for processing graphics corresponding to video data. The processor may be implemented as a system on chip (SOC) in which a core (not shown) is integrated with a GPU (not shown). The processor may include a single core, dual cores, triple cores, quad cores, or cores corresponding to a multiple thereof.

In the following description, for convenience of explanation, an example in which, when the controller 220 performs or controls a certain operation, the processor of the controller 220 performs the certain operation by executing at least one instruction stored in the memory 240 will be described.

In an embodiment of the disclosure, the content output by the display device 200 may be regarded as content viewed by a user of the display device 200. Hereinafter, for convenience of description, ‘information about a history of content obtained by applying weight values according to an embodiment of the disclosure and viewed by the user’ may be referred to as ‘viewing history information’. For example, the viewing history information may include, for example, and without limitation, at least one of a channel viewed by the user of the display device 200 for a certain period before the present time, a name of content (or a name of program) output through the channel, a genre of the content (or the program) output through the channel, a genre of the channel, or the like. In addition, the viewing history information may include a viewing time. The ‘viewing time’ may be a concept that includes not only the concept of time but also the concept of date, day of week, and/or time included in 24 hours a day.

The controller 220 may obtain the viewing history information based on additional data corresponding to the content. The additional data corresponding to the content may refer, for example, to additional data included in a broadcast signal including the content. With regard to the viewing history information, the channel, the genre of the channel, the name of the content, or the genre of the content may be obtained based on the additional data included in the broadcast signal including the content.

For example, the broadcast signal obtained by the display device 200 may include audio and/or video data and the additional data corresponding to the content. The additional data may be referred to as additional information or metadata. In addition, the additional data may include electronic program guide (EPG) information indicating a broadcast schedule. The EPG information may be a program schedule for providing the viewing convenience of broadcast viewers. The EPG information may include information about the title, type, subject, genre, etc. of the content that is a program. Accordingly, when the EPG information corresponding to the viewing time of the user is extracted, information about the content, information about content displayed during the viewing time, the genre of the content, a channel, and/or the genre of the channel may be obtained.

In addition, the controller 220 may use an optical character recognition (OCR) method, an automatic content recognition (ACR) method, etc., to recognize the content viewed by the user, the genre of the content, the channel, and/or the genre of the channel. For example, the controller 220 may recognize the content and/or the channel by performing OCR method or ACR method on a screen itself corresponding to the content.

In addition, when the user inputs a user input for channel selecting to the user interface 210, the controller 220 may recognize the selected and viewed channel based on the user input. In addition, the controller 220 may match and store ‘information about content including at least one of the content, the genre of the content, the channel, the genre of the channel’ or ‘genre time information’ (e.g., the viewing time, day of week, date, etc.) in the memory 240.

In an embodiment of the disclosure, the controller 220 may obtain the viewing history information by applying a first weight having a value smaller than that of a weight applied to a second content to a first content, the second content corresponding to the user input for content selection, the first content being content that does not correspond to the user input. The first content may be content that is not selected through the user input from among contents output from the display device 200. In addition, the content output through the display device 200 may refer to the content viewed by the user. The second content may be content selected through the user input from among the contents output from the display device 200.

In an embodiment of the disclosure, values of the weights applied to the first weight and the second content may be obtained through operation through a neural network. The neural network may perform information processing using, for example, artificial intelligence (AI).

The neural network may receive a plurality of contents output through the display device 200 during a first period, a viewing history indicating the viewing time of the contents, and information about a user input for selecting the contents during the first period, perform operation through at least one layer forming the neural network, and output values of the first weight applied to the first content and at least one weight applied to the second content. Here, the information about the user input may include a type of the user input for selecting content and time information corresponding to the user input.

The values of the first weight and the weight applied to the second content may be set to optimized values through operation through, for example, a deep neural network (DNN). For example, the neural network used in an embodiment of the disclosure may train the viewing history information to select a recommendation channel that best matches a history actually viewed by the user to determine the values of the first weight and the weight applied to the second content.

In an embodiment of the disclosure, the neural network may be, for example, and without limitation, a recurrent neural network (RNN), a bidirectional recurrent deep neural network (BRDNN), a convolution neural network (CNN), etc. In addition, the neural network may be formed in a combination of a plurality of different types of neural networks. The controller 220 may obtain the first weight and a second weight using a long short-term memory (LSTM) neural network which may, for example, include a type of a cyclic neural network (RNN).

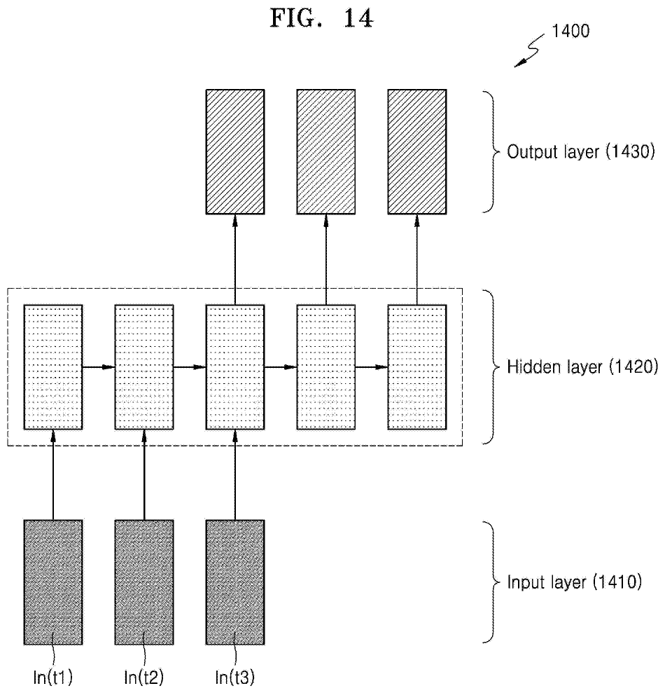

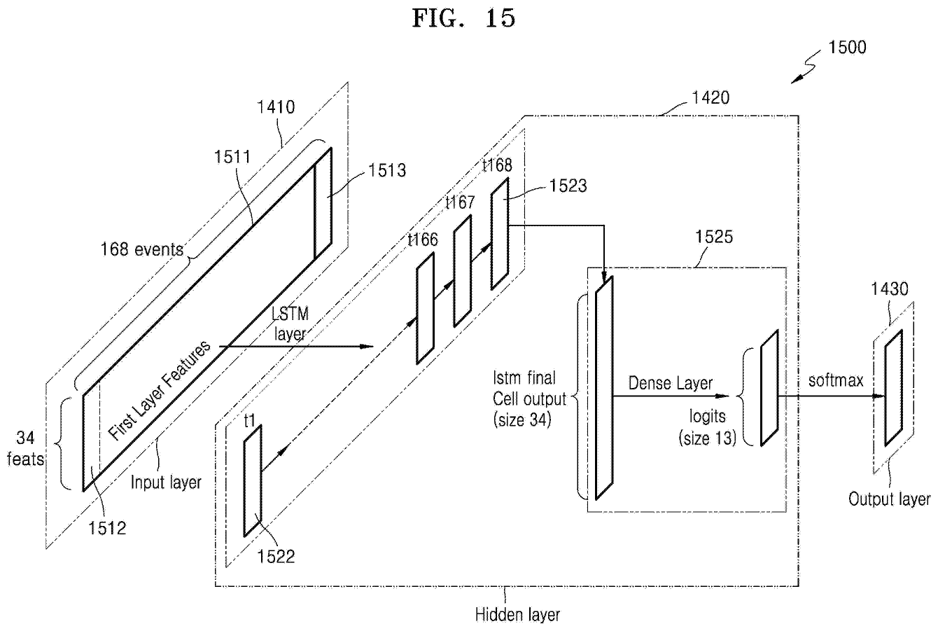

The neural network used in an embodiment of the disclosure will be described in greater detail below with reference to FIGS. 14 and 15.

The first weight and the second weight may be determined by the setting of the controller 220. The first weight and the second weight may be determined by the setting of the user. When weight values are set by the setting of the user, the controller 220 may control a user interface (UI) screen for setting a weight to be output. The user may set the values of the first weight value and the second weight to certain values through the output UI screen.

In addition, with regard to the viewing history information obtained by the controller 220, the first content may correspond to a viewing history having a value of an ‘actual viewing time x the first weight’. In addition, with regard to the viewing history information obtained by the controller 220, the second content may correspond to a viewing history having a value of the ‘actual viewing time x the second weight’.

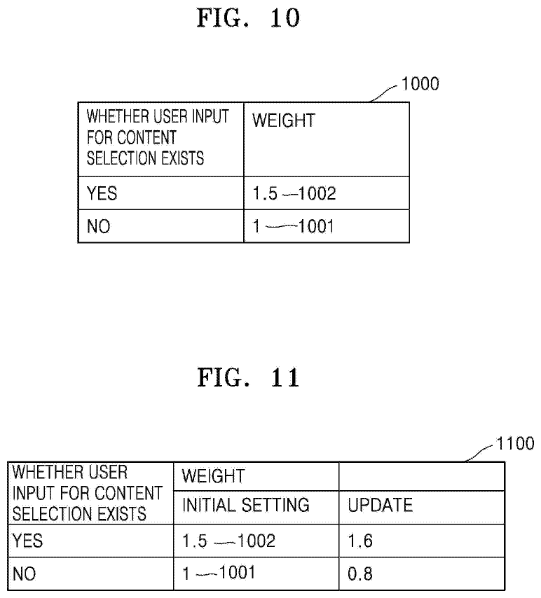

For example, the first weight and the second weight may be set as shown in table 1000 of FIG. 10. Referring to FIG. 10, a first weight 1001 which is applied to the ‘first content’ when the user input for content selection does not exist, and a second weight 1002 which is applied to the ‘second content’ when the user input for content selection exists are illustrated. That is, in an example shown in FIG. 10, it may be set that the second weight 1002=1.5 and the first weight 1001=1.

In the above example, when a user inputs the user input for selecting content to the display device 200 and accordingly views second content for 1 hour, the controller 220 may obtain 1 hour*1.5=1.5 hours as the viewing time of the second content. In addition, when the user outputs first content that does not correspond to the user input for 1 hour (when the user views the second content for 1 hour), the controller 220 may obtain 1 hour*1=1 hour as the viewing time of the first content.

In addition, the controller 220 may differently set a value of the weight applied to the second content according to the type of the user input for selecting the content. For example, in an embodiment of the disclosure, the weight value may be set in accordance with the type of a user input distinguished according to the aggressiveness of the user who selects content to view.

The type of user input may be classified into an input for directly selecting content, an input for selecting a channel, or an input through a channel up key or a channel down key. In the above example, the viewing history information may be obtained by applying a high weight value to content selected by a user input with a high aggressiveness of the user who selects the content to view and applying a low weight value to content selected by a user input with a low aggressiveness of the user.

In an embodiment of the disclosure, in the content selection, the viewing history information may be obtained by distinguishing a user input actively selecting content and a user input manually selecting content and applying different weight values.

The controller 220 may differently set the value of the weight applied to the second content according to the type of the input described above. Hereinafter, an ‘input directly referring to the second content’ may be referred to as a first type of input, and an ‘input referring to a channel providing the second content’ may be referred to as a second type of input, and an ‘input corresponding to the channel up key or the channel down key for selecting the second content’ may be referred to as a third type of input.

The first type of input may include not only wholly inputting a name (a name of program) of the content but also partially inputting the name of the content. However, when a plurality of contents corresponding to a partial input exists, the display device 200 may output a user interface for selecting any one of found contents. In addition, the first type of input may be input to the display device 200 through utterance or a text input. For example, in case of the display device 200 capable of performing a control operation by performing voice recognition, the user may utter to directly refer to the content to view. For example, the user may utter a name of the content to view. The display device 200 may perform voice recognition on the utterance of the user and receive the first type of input.

In addition, the second type of input may be input to the display device 200 through utterance or a text input. For example, the user may use a keypad (not shown) output through a user interface of the display device 200 or a remote controller (not shown) for controlling the display device 200, to input the second type of input by text. As another example, the user may utter a number (e.g., number 11) of a channel or a name (e.g., MBC) of the channel to view, to input the second type of input by voice.

In addition, the third type of input may be input to the display device 200 through utterance or selection of a key (e.g., the channel up key or the channel down key) included in the remote controller (not shown) or the user interface 210. For example, in case of the display device 200 capable of performing the control operation by performing voice recognition, the user may utter ‘channel up’ or ‘channel down’. Then, the display device 200 may perform voice recognition on the utterance of the user and receive the third type of input. As another example, the user may use the keypad (not shown) output through the user interface of the display device 200 or the channel up key or the channel down key included in the remote controller (not shown) for controlling the display device 200, to input the third type of input by text.

For example, when the user wants to view content (or program) ‘Talk Issues Say Current Events’ through a channel 11 (see, e.g., FIG. 9) (a channel provided through the MBC broadcasting station, referred to as ‘MBC’), the user may select the content through various input methods.

In the above example, according to the first type of input, the user may utter directly ‘Talk Issues Say Current Events’ or input ‘Talk Issues Say Current Events’ by text to the display device 200. The user may utter or text input a part of a content name such as ‘talk current events’, ‘talk current events issues’ or ‘say issues’. According to the second type of input, the user may utter or text input ‘MBC’ or ‘11’. In addition, according to the third type of input, the user may search for the channel 11 using the channel up key or the channel down key.

In addition, the controller 220 may obtain the viewing history information by applying the second weight to the second content when the second content is selected through the first type of input, applying a third weight to the second content when the second content is selected through the second type of input, and applying a fourth weight to the second content when the second content is selected through the third type of input. Here, it may be set that the second weight>the third weight>the fourth weight>the first weight.

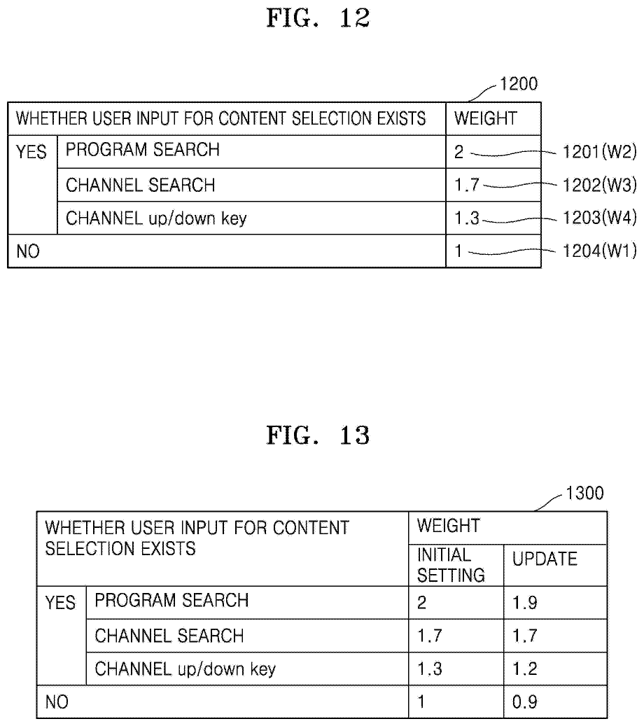

For example, the first to fourth weights may be set as shown in table 1200 of FIG. 12. Referring to FIG. 12, a first weight 1204 which is a weight applied to ‘first content’ when a user input for content selection does not exist, a second weight 1201 which is a weight applied to second content selected through a first type of input, a third weight 1202 which is a weight applied to the second content selected through a second type of input, and a fourth weight 1203 which is a weight applied to the second content selected through a third type of input are illustrated. That is, in an example shown in FIG. 12, it may be set that the first weight=1, the second weight=2, the third weight=1.7, and the fourth weight=1.3.

For example, a name of content (or a name of program) is ‘KBS News 9’, and the content is provided through channel 9 or the KBS1 broadcasting station. In this case, when a user inputs voice or text directly referring to the name of content ‘KBS News 9’ to the display device 200, to view the content (that is, when the second type of input exists), the user may be considered to want to view the content first of all. Accordingly, viewing history information may be obtained by applying the highest weight value to the content selected corresponding to the second type of input.

In addition, when the user inputs voice or text indicating channel 9 or the KBS1 broadcasting station to the display device 200 (that is, when the third type of input exists), it may be seen that the user has preferred to the channel rather than viewed the content itself. Accordingly, when selecting the content through the second type of input, it may be seen that the user actively wanted to view the content than when selecting the content through the third type of input. Therefore, the second weight may have a value greater than the third weight.

In addition, when the user selects and views the ‘KBS News 9’ content provided on channel 9 using the channel up key or the channel down key (that is, the fourth type of input exists), the aggressiveness of the user for viewing the content may be lower than that of the above-described second type of input or third type of input. Therefore, the fourth weight may have a smaller value than the second weight or the third weight.

As described above, in an embodiment of the disclosure, the viewing history information may be obtained by applying different weights according to whether the user input for selecting certain content exists. Accordingly, in selecting a recommendation channel, content that is actively desired and viewed by the user may be considered more, and thus the content that further accords with the intention of the user may be determined as the recommendation channel. Accordingly, satisfaction of the user who receives a recommendation channel service may increase.

Obtaining of the viewing history information will be described in greater detail below with reference to FIGS. 8 and 9.

The controller 220 may control the viewing history information to be obtained.

When the display device 200 displays certain content corresponding to a certain channel, the controller 220 may control the viewing history of the user corresponding thereto to be stored in the memory 240. When viewing of the certain content ends, the controller 220 may store the viewing history information of the user corresponding thereto in the memory 240.

In addition, when the viewing time is too short, it may be difficult to determine that the user viewed the certain content. Therefore, when the viewing time with respect to the channel is equal to or more than a certain time (e.g., 10 minutes or 20 minutes), the controller 220 may store the viewing history information about the channel displayed for the certain time or more in the memory 240.

The viewing history information may represent information about contents that the user has viewed through the display device 200 for a certain period. For example, the viewing history information may include the information about contents that the user has viewed through the display device 200 for the certain period and the viewing time corresponding thereto. Also, the information about the content may include at least one of a channel corresponding to the viewed content, a name of the viewed content, or genre information of the viewed content.

The genre may include information indicating a type of content, and may be a classification range for classifying image content. For example, genres may be classified into sports, movies, dramas, music, news, lifestyles, documentaries, children, animation, entertainment, etc. In addition, in more detail, genres may be classified into detailed genres such that a sports genre may be classified into baseball, soccer, golf, etc. Genres may be classified into dramas, movies, animation, entertainment, sports, hobby, music, education, affairs, news, documentaries, and shopping.

In addition, the certain period may be a period corresponding to recent days and recent weeks with respect to the current time. For example, the viewing history information may include the viewing time of content viewed by the user during recent two weeks, recent three weeks, or recent four weeks with respect to the current time, a channel, the content (or a program name), a genre of the content, and/or a genre of the channel.

In addition, the viewing history information may be obtained with respect to each of a plurality of users when the plurality of users uses the display device 200. For example, when a TV which is the display device 200 exists at home, the whole family member may view content through the display device 200. When the total three family members include a mother, a father, and a child, the display device 200 may individually recognize users. The display device 200 may obtain and store viewing history information about each of the mother, the father, and the child. Here, the display device 200 may distinguish and recognize users by performing an operation such as voice recognition and user authentication.

In addition, the controller 220 may generate a recommendation list based on the viewing history information obtained by applying the weight (see, e.g., S720 in FIG. 7). The recommendation list may include at least one recommendation channel including a channel and/or content to be preferred by the user selected based on the viewing history of the user. For example, the controller 220 may generate the recommendation list based on the viewing history information obtained during a past certain time interval with respect to the generation time of the recommendation list. The recommendation list may be output by a request of the user or by the setting of the controller 220 itself. For example, when the display device 200 is turned on, the controller 220 may control the recommendation list to be automatically output. When the user requests an output of the recommendation list, the controller 220 may control the recommendation list to be output in response to the request of the user (see, e.g., S730 in FIG. 7).

The controller 220 may generate the recommendation list including at least one channel that the user has viewed a lot based on the viewing history information. The controller 220 may select at least one recommendation channel in order of channels that the user has viewed the most and generate the recommendation list including the selected at least one recommendation channel, based on the viewing history information of the user.

In addition, the controller 220 may generate the recommendation list including a recommendation channel corresponding to at least one content provided through the at least one channel that the user has viewed a lot based on the viewing history information. For example, the controller 220 may generate the recommendation list using a channel that provides content included in the same genre as the content that the user has viewed a lot as the recommendation channel based on the viewing history information. For example, with regard to the viewing history information, when the user views sports content a lot, the controller 220 may generate the recommendation list including at least one channel providing the sports content as the recommendation channel.

In addition, the controller 220 may generate the recommendation list including the same channel as the at least one channel viewed by the user as the recommendation channel and including a channel providing content included in the same or similar genre as or to the content viewed by the user as the recommendation channel based on the viewing history information. That is, the controller 220 may generate the recommendation list by considering all the channels and genres viewed by the user.

In addition, the controller 220 may transmit the viewing history information to a server providing a service customized for each individual. In recent years, to provide more effectively services and advertisements by increasing user satisfaction, companies or servers collect personal information of users and provide personalized services or advertisements. For example, a personalization service providing server (not shown) may provide an advertisement of a travel product, an article, a restaurant, etc. corresponding to a place that appeared in the content viewed by the user. Therefore, in an embodiment of the disclosure, using the viewing history information reflecting the aggressiveness of the user with regard to content viewing, a personalization service that further accords with tendency and intention of the user.

Therefore, in an embodiment of the disclosure, the controller 220 may transmit the viewing history information to a server (not shown) that provides the above-described personalization service or advertisement. In this case, the controller 220 may control a user interface for confirming permission of the user to be output before transmitting the viewing history information to the above-described server. In addition, the controller 220 may transmit the viewing history information to the above-described server (not shown) only when the user permits transmission of the viewing history information.

The display 230 may output an image corresponding to video data through an internally included display panel to allow the user to visually recognize the video data under the control of the controller 220. For example, the display 230 may display a user interface screen including the recommendation list under the control of the controller 220. In addition, the display 230 may display content provided through a channel selected in response to a user input under the control of the controller 220.

FIG. 3 is a block diagram illustrating an example display device 300 according to another embodiment of the disclosure. The display device 300 illustrated in FIG. 3 corresponds to the display device 200 illustrated in FIG. 2. In the display devices 200 and 300, the same reference numerals denote the same elements, and thus, redundant descriptions provided above in relation to FIGS. 1 and 2 will not be repeated to describe the display device 300 shown in FIG. 3.

Referring to FIG. 3, the display device 300 may further include a communicator (e.g., including communication circuitry) 250 as compared to the display device 200.

The communicator 250 may include various communication circuitry and communicate with an external device (not shown) to receive at least one certain content transmitted through a certain channel. The communicator 250 may receive at least one of a plurality of contents corresponding to a plurality of channels.

The channel may be a broadcast channel. In addition to the broadcast channel, the channel may refer, for example, to a content transmission path corresponding to a content provider that transmits certain content. For example, the channel may refer, for example, to a transmission path through which a video on demand (VoD) service and/or a streaming content providing service are/is transmitted in addition to the broadcast channel, and may be represented in the form of a certain number, a certain character, or a combination of the certain character and the certain number like the broadcast channel. For example, the communicator 250 may receive a certain streaming movie providing service through channel ‘20’, and a user of the display device 300 may view movie content provided by the certain streaming movie providing service when selecting channel ‘20’. As another example, when the content provider is the KBS1 broadcasting station, the content may be received through channel ‘7’, and the channel may be represented by a character ‘KBS1’. In this case, the user may view the content provided by the KBS1 broadcasting station by inputting a channel number ‘7’. The user may view the content provided by the KBS1 broadcasting station by inputting the character ‘KBS1’.

The communicator 250 may communicate with at least one external device (not shown) through a wired or wireless network. The external device (not shown) may be a device capable of transmitting certain content to the display device 200 through a certain channel, and may include a broadcasting station server, a content provider server, and a content storage device.

The communicator 250 according to an embodiment of the disclosure may include at least one communication module including various communication circuitry, such as a broadcast receiving module, a short-range communication module, a wired communication module, a mobile communication module, etc. The at least one communication module may refer, for example, to a communication module capable of transmitting and receiving data through a network conforming to communication standards such as a tuner performing broadcast receiving, Bluetooth, WLAN (or Wi-Fi), wireless broadband (Wibro), world interoperability for microwave access (Wimax), code division multiple access (CDMA), or wideband CDMA (WCDMA).

The communicator 250 may further include a communication module (not shown) that performs communication with the remote controller (not shown). For example, the communication module (not shown) that performs communication with the remote controller (not shown) may include an optical receiver for transmitting and receiving data according to an infrared signal, a Zigbee module for transmitting and receiving a Zigbee signal, etc.

The communicator 250 may further include an optical receiver (not shown) (equally corresponding to the optical receiver 463 of FIG. 4) that performs communication with the remote controller (not shown). Specifically, the optical receiver (not shown) may receive an optical signal corresponding to a user input (e.g., touch, push, a touch gesture, voice, or motion) entered through the remote controller (not shown). A control signal may be extracted from the received optical signal under the control of the controller 220.

For example, the remote controller (not shown) may receive a user input for content selection by manipulation of the user. Specifically, the remote controller (not shown) may include a plurality of keypads for inputting at least one of text or numbers, a channel up key, a channel down key, a volume up key, a volume down key, etc. The user may manipulate the channel up key or the channel down key of the remote controller (not shown) for content selection. In addition, the user may directly input a name of the content by manipulating the keypads for text input of the remote controller (not shown) for content selection. In addition, the user may input a channel number by manipulating the keypad for number input of the remote controller (not shown) for content selection. The remote controller (not shown) may generate and output an optical signal corresponding to a user input. The light receiver (not shown) of the display device 300 may receive the optical signal output from the remote controller (not shown).

In addition, the display device 300 may include the optical receiver (not shown) as a separate element other than an element included in the communicator 250.

FIG. 4 is a block diagram illustrating an example display device 400 according to another embodiment of the disclosure. The display device 400 may equally correspond to the display device 200 or 300 described above in relation to FIGS. 1 to 3. For example, a communicator 450, a controller 480, a display 415, and a memory 490 of the display device 400 may respectively correspond to the communicator 250, the controller 220, the display 230, and the memory 24 of the display device 200 or 300 shown in FIG. 2 or 3. In addition, in addition to the elements illustrated in FIG. 4, the display device 400 may further include an element corresponding to the user interface 210 illustrated in FIG. 2.

Therefore, the redundant descriptions provided above in relation to FIGS. 1 to 3 will not be repeated to describe the display device 400.

Referring to FIG. 4, the display device 400 includes a video processor (e.g., including video processing circuitry) 410, the display 415, an audio processor (e.g., including audio processing circuitry) 420, an audio outputter (e.g., including audio output circuitry) 425, a power supply 430, a tuner 440, the communicator (e.g., including communication circuitry) 450, a sensor 460, an inputter/outputter (e.g., including input/output circuitry) 470, the controller (e.g., including processing circuitry) 480, and the memory 490.

The video processor 410 may include various video processing circuitry that processes video data received by the display device 400. The video processor 410 may perform various video processing operations such as video data decoding, scaling, noise filtering, frame rate conversion, and resolution conversion.

The controller 480 may include various processing circuitry and receive a request to record the video data processed by the video processor 410, and control the video data to be encoded and recorded on a memory device (not shown), e.g., RAM (not shown), included in the controller 480 or the memory 490.

The display 415 displays video data included in a broadcast signal received through the tuner 440, on a screen under the control of the controller 480. The display 415 may display content (e.g., a moving image) input through the communicator 450 or the inputter/outputter 470.

The display 415 may output an image stored in the memory 490, under the control of the controller 480. The display 415 may display a voice UI (for example, including a voice instruction guide) for performing a task corresponding to recognized voice, or a motion UI (for example, including a user motion guide for motion recognition) for performing a task corresponding to recognized motion.

The audio processor 420 may include various audio processing circuitry and processes audio data. The audio processor 420 may perform various processing operations such as audio data decoding or amplification, and noise filtering. The audio processor 420 may include a plurality of audio processing modules to process audio data corresponding to a plurality of contents.

The audio outputter 425 may include various audio output circuitry and outputs audio data included in the broadcast signal received through the tuner 440, under the control of the controller 480. The audio outputter 425 may output audio data (e.g., voice or sound) input through the communicator 450 or the inputter/outputter 470. The audio outputter 425 may output audio data stored in the memory 490, under the control of the controller 480. The audio outputter 425 may include, for example, and without limitation, at least one of a speaker 426, a headphone output port 427, and a Sony/Philips digital interface (S/PDIF) output port 428. The audio outputter 425 may include a combination of the speaker 426, the headphone output port 427, and the S/PDIF output port 428.

The power supply 430 supplies power input from an external power source, to the other elements 410 to 490 in the display device 400 under the control of the controller 480. The power supply 430 may supply power output from one or more batteries (not shown) located in the display device 400, to the other elements 410 to 490.

The tuner 440 may be tuned to and select only a frequency of a channel desired to be received by the display device 400 from among many radio wave components by performing, for example, amplification, mixing, and resonance on a broadcast signal received in a wired or wireless manner. The broadcast signal includes audio data, video data, and additional information (e.g., an electronic program guide (EPG)).

The tuner 440 may selectively receive a broadcast signal and/or an image signal received corresponding to a certain channel.

The tuner 440 may receive the broadcast signal in a frequency band corresponding to a channel number (e.g., cable broadcast 506) according to a user input. Here, the user input may be a control signal received from an external control device (not shown) or a remote controller (not shown), for example, a channel number input, a channel up-down input, and a channel input on an EPG screen. In addition, the user input may be an input for generating a certain event.

The tuner 440 may receive the broadcast signal from various sources such as terrestrial, cable, satellite, and Internet broadcasters. The tuner 440 may receive the broadcast signal from sources such as analog and digital broadcasters. The broadcast signal received through the tuner 440 may be decoded (e.g., audio-decoded, video-decoded, or additional-information-decoded) into the audio data, video data, and/or additional information. The decoded audio data, video data, and/or additional information may be stored in the memory 490 under the control of the controller 480.

The display device 400 may include one or more tuners 440. When a plurality of tuners 440 are included according to an embodiment of the disclosure, a plurality of broadcast signals may be output on a plurality of windows included in a multi-window screen provided on the display 415.

The tuner 440 may be integrated with the display device 400 in the form of an all-in-one device, or be implemented as a separate device having a tuner electrically connected to the display device 400 (e.g., a set-top box (not shown) or a tuner (not shown) connected to the inputter/outputter 470.

The communicator 450 may include various communication circuitry and connect the display device 400 to an external device (e.g., an audio device) under the control of the controller 480. The controller 480 may transmit or receive content to or from the connected external device, download an application from the external device, or perform web browsing through the communicator 450. Specifically, the communicator 450 may access a network to receive content from an external device (not shown).

As described above, the communicator 450 may include at least one of a short-range wireless communication module (not shown), a wired communication module (not shown), or a mobile communication module (not shown).

FIG. 4 illustrates an example in which the communicator 450 includes, for example, at least one of a WLAN module 451, a Bluetooth 452, and a wired Ethernet module 453.

The communicator 450 may include a combination of two or more of the WLAN module 451, the Bluetooth 452, and the wired Ethernet module 453. The communicator 450 may receive a control signal of the external controller (for example, remote controller) under the control of the controller 480. The control signal may be implemented in a Bluetooth type, a radio frequency (RF) signal type, or a Wi-Fi type.

The communicator 450 may further include a non-Bluetooth short-range wireless communication module (e.g., a near field communication (NFC) module (not shown)) and a separate Bluetooth low energy (BLE) module (not shown).

In addition, in FIG. 4, the tuner 440 and the communicator 450 may correspond to the communicator 250 of FIG. 2, and may be implemented in which the communicator 450 further includes the tuner 440.

The sensor 460 may include various sensors and may sense a voice of a user, an image of the user, or interaction of the user. The sensor 460 may correspond to the user interface 210 described in FIG. 2.

A microphone 461 receives voice uttered by the user. The microphone 461 may convert the received voice into an electrical signal and output the electrical signal to the controller 480. The voice of the user may include, for example, voice corresponding to a menu or a function of the display device 400. For example, a recognition range of the microphone 461 is recommended within a distance of 4 m from the microphone 461 to the location of the user, and may vary depending on a voice volume of the user and an ambient environment (e.g., a speaker volume and ambient noise).

The microphone 461 may be integrated with or separate from the display device 400. The separate microphone 461 may be electrically connected to the display device 400 through the communicator 450 or the inputter/outputter 470.

It will be understood by one of ordinary skill in the art that the microphone 461 may be excluded depending on the performance and structure of the display device 400.

A camera 462 receives an image (e.g., consecutive frames) corresponding to motion (including a gesture) of the user in a recognition range of the camera 462. For example, the recognition range of the camera 462 may be within a distance of 0.1 m to 5 m from the camera 462 to the user. The motion of the user may include, for example, a gesture or motion of a body part of the user, e.g., the face, a hand, a fist, or a finger. The camera 462 may convert the received image into an electrical signal and output the electrical signal to the controller 480 under the control of the controller 480.

The controller 480 may select a menu to be displayed on the display device 400 or perform a control operation based on the received motion recognition result. For example, the controller 480 may switch channels, control a volume, or move an indicator.

The camera 462 may include a lens (not shown) and an image sensor (not shown). The camera 462 may support optical zoom or digital zoom using a plurality of lenses and an image processor. The recognition range of the camera 462 may be variously set based on an angle of the camera 462 and an ambient environment condition. When the camera 462 includes a plurality of cameras, a 3-dimensional still image or a 3-dimensional moving image may be received using the plurality of cameras.

The camera 462 may be integrated with or separate from the display device 400. A device (not shown) including the separate camera 462 may be electrically connected to the display device 400 through the communicator 450 or the inputter/outputter 470.

It will be understood by one of ordinary skill in the art that the camera 462 may be excluded depending on the performance and structure of the display device 400.

An optical receiver 463 receives an optical signal (including a control signal) from the external controller through, for example, an optical window (not shown) of a bezel of the display 415. The optical receiver 463 may receive, from the external controller, an optical signal corresponding to user input (e.g., touch, push, a touch gesture, voice, or motion). A control signal may be extracted from the received optical signal under the control of the controller 480.

For example, the optical receiver 463 may receive a signal corresponding to a pointing location of the external controller, and transmit the signal to the controller 480. For example, when a UI screen for receiving data or a command from the user is output on the display 415 and the user desires to input data or a command to the display device 400 through the external controller, and when the user moves the external controller while touching a finger on a touchpad (not shown) provided on the external controller, the optical receiver 463 may receive a signal corresponding to the motion of the external controller, and transmit the signal to the controller 480. The optical receiver 463 may receive a signal indicating that a specific button provided on the external controller is pressed, and transmit the signal to the controller 480. For example, when the user presses, with a finger, a button-type touchpad (not shown) provided on the external controller, the optical receiver 463 may receive a signal indicating that the button-type touchpad is pressed, and transmit the signal to the controller 480. For example, the signal indicating that the button-type touchpad is pressed may be used as a signal for selecting one of items.

The inputter/outputter 470 may include various input/output circuitry and receives, for example, video data (e.g., a moving image), audio data (e.g., voice or music), and additional information (e.g., an EPG) from outside the display device 400 under the control of the controller 480. The inputter/outputter 470 may include at least one of a high-definition multimedia interface (HDMI) port 471, a component jack 472, a PC port 473, and a universal serial bus (USB) port 474. The inputter/outputter 470 may include a combination of the HDMI port 471, the component jack 472, the PC port 473, and the USB port 474.

It will be understood by one of ordinary skill in the art that the configuration and operation of the inputter/outputter 470 may be implemented in various ways according to an embodiment of the disclosure.

The controller 480 controls overall operations of the display device 400 and signal flows between the elements of the display device 400, and processes data. When user input is received or a preset condition is satisfied, the controller 480 may execute an operating system (OS) and various applications stored in the memory 490.

The controller 480 may include RAM (not shown) storing signals or data input from outside the display device 400 or used as a storage area for various operations performed by the display device 400, ROM (not shown) storing a control program for controlling the display device 400, and a processor (not shown).

The processor may include a GPU (not shown) for processing graphics corresponding to video data. The processor may be implemented as a SOC in which a core (not shown) is integrated with a GPU (not shown). The processor may include a single core, dual cores, triple cores, quad cores, or cores corresponding to a multiple thereof.

The processor may include a plurality of processors. For example, the processor may include a main processor (not shown) and a sub-processor operating in a sleep mode.

The GPU may generate a screen including various objects such as icons, images, and text using a calculator (not shown) and a renderer (not shown). The calculator calculates attribute values such as a coordinate, a shape, a size, and a color of each object to be displayed, based on a screen layout using user interaction sensed by the sensor 460. The renderer generates a screen of various layouts including objects, based on the attribute values calculated by the calculator. The screen generated by the renderer is displayed in a display area of the display 415.

In an embodiment of the disclosure, the controller 480 may perform an operation of generating a recommendation list.

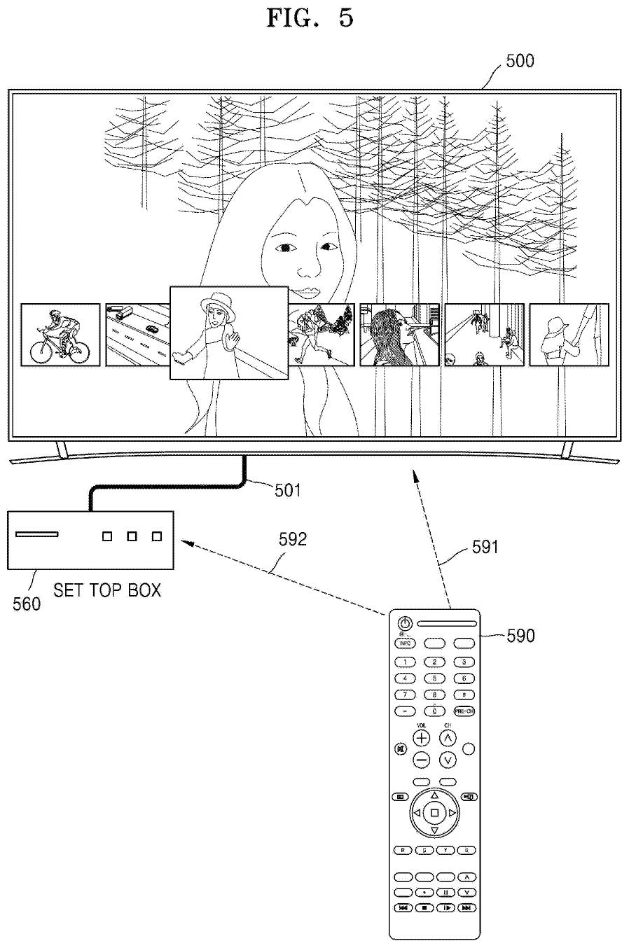

FIG. 5 is a diagram illustrating an example display device 500 according to another embodiment of the disclosure.

Referring to FIG. 5, the display device 500 according to an embodiment of the disclosure may correspond to the display device 200, 300, or 400 illustrated in FIG. 2, 3, or 4.

The display device 500 may receive content from a set top box 560 which is an external device. When the display device 500 receives the content directly from an external device (not shown) that provides the content through the communicator 250, the display device 500 may receive the content from the set top box 560. In addition, the display device 500 may be connected to the set top box 560 by wired or wirelessly.

Referring to FIG. 5, the set top box 560 may be a digital broadcasting transmission/reception equipment and may be connected to the display device 500 through a dedicated line 501. The dedicated line 501 may be a dedicated cable line for connection between the set top box 560 and the display device 500.

The set top box 560 may receive broadcast from content providers corresponding to a cable channel, a general service program channel, a VOD service providing channel, etc. Based on a control signal 592 output from a remote controller 590, the set top box 560 may selectively receive a channel or content requested by a user. The set top box 560 may receive the channel or the content requested by the user and transmit the received channel or content to the display device 500.

Referring to FIG. 5, the user may turn on the display device 500 by manipulating the remote controller 590. When the remote controller 590 outputs a control signal 591 for requesting the display device 500 to turn on, the display device 500 is turned on. In addition, when the display device 500 is turned on, the set top box 560 may be automatically turned on. In addition, when a content input source of the display device 500 is set to the set top box 560, and the display device 500 is turned on, the display device 500 may transmit a turn on signal to the set top box 560. Through a separate manipulation of the user, the set top box 560 may be turned on.

When the content input source of the display device 500 is set to the set top box 560, and both the set top box 560 and the display device 500 are turned on, the display device 500 may transmit a control signal corresponding to a user input received from the remote controller 590 to the set top box 590. The control signal may be directly transmitted by the display device 500 to the set top box 560. Also, the control signal may be transmitted by the remote controller 590 to the set top box 560. As described above, the display device 500 may identify what kind of input method the user has used to select the content output from the set top box 560.

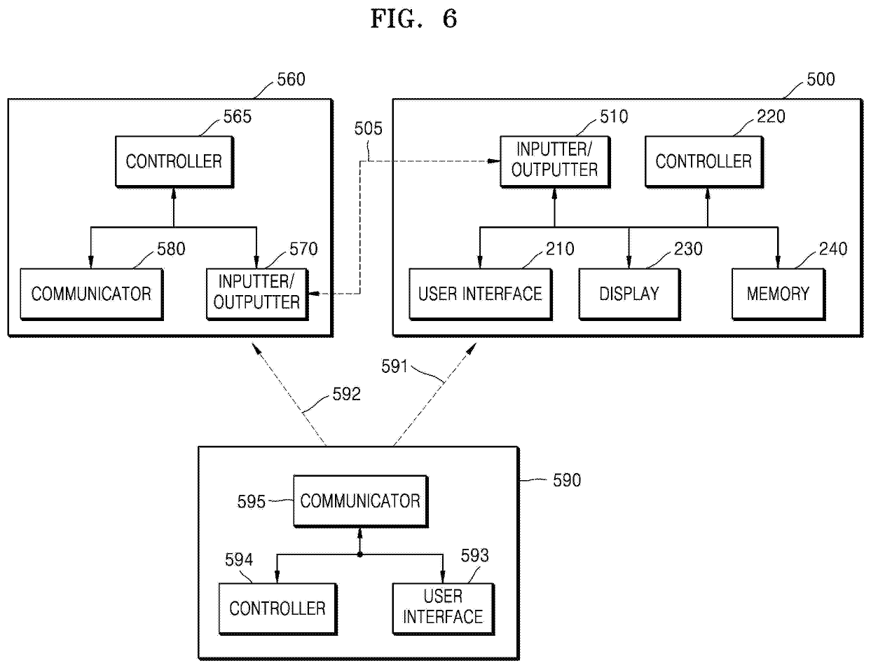

FIG. 6 is a block diagram illustrating the display device 500 illustrated in FIG. 5. In FIGS. 2, 3, 4, 5 and 6, the same reference numerals denote the same elements. Therefore, the redundant descriptions provided above in relation to FIGS. 2 to 5 will not be repeated to describe the embodiment of the disclosure shown in FIG. 6.

Referring to FIG. 6, the display apparatus 500 according to an embodiment of the disclosure may further include an inputter/outputter (e.g., including input/output circuitry) 510 as compared to the display device 200 illustrated in FIG. 2. The inputter/outputter 510 may correspond to the inputter/outputter 470 of FIG. 4.

Referring to FIG. 6, the remote controller 590 includes a controller (e.g., including processing circuitry) 594, a communicator (e.g., including communication circuitry) 595, and a user interface 593.

The user interface 593 may include various interface circuitry for interacting with a user and may include an input device (not shown) capable of receiving a user input.

The user interface 593 may include a user input device (not shown) including, for example, a touch panel for sensing touch input of a user, buttons for receiving push input of the user, a wheel for receiving rolling or scrolling input of the user, a keyboard, or a dome switch, but is not limited thereto. For example, the input device (not shown) included in the user interface 593 may include a plurality of keypads for inputting at least one of text or numbers, a channel up key, a channel down key, a volume up key, a volume down key, etc.

The controller 594 may include various processing circuitry and generally controls the operation of the remote controller 590. The controller 594 may output a control signal corresponding to a user input input through the user interface 593 to the set top box 560 or the display device 500.

The communicator 595 may include various communication circuitry and transmit the control signal corresponding to the user input to the set top box 560 or the display device 500 under the control of the controller 594. The communicator 595 may further include an optical receiver (not shown) for transmitting the control signal to the set top box 560 or the display device 500.

Referring to FIG. 6, the set top box 560 includes the controller (e.g., including processing circuitry) 565, the communicator (e.g., including communication circuitry) 595, and an inputter/outputter (e.g., including input/output circuitry) 570.

The communicator 580 may include various communication circuitry and communicate with an external device (not shown) to receive at least one certain content through a certain channel. The communicator 580 may receive at least one of a plurality of contents corresponding to a plurality of channels. The communicator 580 may receive broadcast from content providers corresponding to a cable channel, a general service program channel, a VOD service providing channel, etc. The communicator 580 may selectively receive a channel or content requested by the user under the control of the controller 565.

In addition, the communicator 580 may further include an optical receiver (not shown) that receives the control signal 592 output from the remote controller 590. To receive the control signal 592 output from the remote controller 590, the display device 500 may further include a separate wireless communicator (not shown). The communicator 580 may receive the control signal 592 output from the remote controller 590 and transmit the control signal 592 to the controller 565. The controller 565 may control the communicator 580 to selectively receive the channel or the content requested by the user based on the control signal 592.

In addition, the operation performed by the communicator 580 is the same as or similar to that of the communicator 250 illustrated in FIG. 3, and thus a redundant description will be omitted.

The controller 565 may include various processing circuitry and generally controls the operation of the set top box 560. The controller 565 may control content received from the external device (not shown) through the communicator 580 to be transmitted to the display device 500 through the inputter/outputter 570.

The inputter/outputter 570 may include various input/output circuitry electrically connected to an external device (e.g., the display device 500). The inputter/outputter 570 may transmit video data (e.g., a moving image), audio data (e.g., voice or music), and/or additional information (e.g., an EPG) received through the communicator 580 to the display device 500 under the control of the controller 560. The inputter/outputter 570 may include at least one of a high-definition multimedia interface (HDMI) port, a component jack, a PC port, and a universal serial bus (USB) port. For example, the inputter/outputter 570 may include an HDMI port (not shown). The set top box 560 may transmit at least one of video data or audio data corresponding to the content to the display device 500 through a wired cable 505 connected through the HDMI port (not shown). In addition, the additional data (e.g., EPG) may be transmitted to the display device 500 through a wireless communicator (not shown) included in the set top box 560.

In addition, the above-described additional data is data output from the set-top box 560 and may include data representing an output schedule of the content. The display device 500 may receive the metadata from the set top box 560 and generate viewing history information based on the received metadata and information about a user input (e.g., information including a type of the user input for selecting content, and time information corresponding to the user input).

The display device 500 may receive the metadata from an external server (e.g., a server for providing content, a broadcasting station server, etc.) based on information of the set top box 560.

For example, the display device 500 may receive content from the set top box 560 and display the received content. In this case, the display device 500 may obtain information about the user input for selecting the content and received from the remote controller 590. The display device 500 may receive the metadata from the set top box 560. The display device 500 may know how the user selects and views the content output from the set top box 560 based on the information about the user input and the metadata. That is, the display device 500 may generate viewing history information based on the information about the user input and the metadata.

Referring to FIG. 6, the display device 500 includes the inputter/outputter 510, the user interface 210, the controller 220, the display 230, and the memory 240.

A configuration of the inputter/outputter 510 equally corresponds to the configuration of the inputter/outputter 570, and thus a detailed description thereof will not be repeated here. The inputter/outputter 510 is an element electrically connected to an external device (e.g., the set top box 560). The inputter/outputter 510 may receive at least one of audio data, video data, or additional data corresponding to the content from the set-top box 560 under the control of the controller 220.

As illustrated in FIG. 6, when the set top box 560 receives the content, the set top box 560 may also receive additional data of the content including EPG information corresponding to the content. The set top box 560 may transmit the received additional data to the display device 500. When the set top box 560 transmits the video data and/or the audio data corresponding to the content through the wired cable 505, the controller 565 of the set top box 560 may control the additional data corresponding to the content to be transmitted to the display device 500 together. The set top box 560 may transmit the additional data corresponding to the content to the display device 500 through a separately formed wireless communicator (not shown, included in the set top box 560). As a result, the display device 500 may obtain information (e.g., the additional data) about the content received from the set top box 560 and may update viewing history information based on the additional data.

The display device 500 may receive information about all channels that the set top box 560 may output from an external server (not shown), based on identification information of the set top box 560 received through the inputter/outputter 510 or a wireless communicator (not shown, included in the display device 500). Additionally, the display device 500 may obtain a channel number with respect to an image currently displayed on a screen using an OCR method, an ACR method, etc. Accordingly, the display device 500 may obtain information about content that the user views through the set top box 560 based on the information about all channels received from the external server (not shown) and the obtained channel number.

In addition, based on the information about the user input received from the remote controller 590 described above, the display device 500 may determine what input the user has provided to the set top box 560. As a result, the controller 220 of the display device 500 may identify what content the user views through the set top box 560 and what selection method is used to select the content. The display device 500 may generate or update the viewing history information using the identified content and the selection method.

Hereinafter, referring to the display device 300 illustrated in FIG. 3 and FIGS. 7, 8, 9, 10, 11, 12, 13, 14, 15, 16 and 17, a method of providing a recommendation list according to an embodiment of the disclosure and specific operations of the display device 300 using the method will be described in greater detail below.

FIG. 7 is a flowchart illustrating an example method 700 of providing a recommendation list according to an embodiment of the disclosure. FIG. 7 is a flowchart illustrating an example operation performed by the display device 100, 200, 300, 400, or 500 according to an embodiment of the disclosure described with reference to FIGS. 1, 2, 3, 4, 5 and 6 (which may be referred to hereinafter as FIGS. 1 to 6). The method 700 of providing the recommendation list according to an embodiment of the disclosure may be performed through the display device 100, 200, 300, 400, or 500 according to an embodiment of the disclosure described with reference to FIGS. 1 to 6 and, operations performed by the display device 100, 200, 300, 400, or 500 may equally correspond to operations included in the method 700 of providing the recommendation list. Therefore, the redundant descriptions provided above in relation to FIGS. 1 to 6 will not be repeated to describe the method 700 of providing the recommendation list. Hereinafter, an example in which the method 700 of providing the recommendation list is performed through the display device 300 shown in FIG. 3 is illustrated.

Referring to FIG. 7, the method 700 of providing the recommendation list may obtain viewing history information representing a history of contents viewed by a user for a certain period (S710). The method 700 of providing the recommendation list may obtain the viewing history information by applying a first weight having a value smaller than that of a weight applied to a second content to first content, the second content corresponding to content based on a user input for content selection, the a first content corresponding to content that does not correspond to the user input. Operation S710 may be performed by the controller 220.

And, the method 700 of providing the recommendation list may generate a recommendation list including at least one recommendation channel based on the generated viewing history information (S720). Operation S720 may be performed by the controller 220.

Further, the method 700 of providing the recommendation list may provide the recommendation list (S730). For example, the controller 220 may control a screen including the recommendation list to be displayed via a display 230.

An operation of obtaining the viewing history information will be described in detail with reference to FIGS. 8, 9, 10, 11, 12 and 13 (which may be referred to hereinafter to FIGS. 8 to 13).

FIG. 8 is a diagram illustrating example information representing a viewing history of a user used in an embodiment of the disclosure.

FIG. 8 is a diagram illustrating an actual viewing history 800 of the user obtained for a set time interval. Hereinafter, for convenience of description, information representing a history of which channel or program and for which hours the user has actually viewed for the set time interval corresponding to a certain day of week, date, and is referred to as the ‘actual viewing history’ 800. In addition, the viewing history obtained by applying weight values (e.g., a first weight, a second weight, etc.) according to an embodiment of the disclosure to the actual viewing history 800 is referred to as ‘viewing history information’. In addition, FIG. 8 illustrates an example in which a certain period is set to 5 days and the viewing history of the user for 5 days is obtained, but the time interval for which the actual viewing history 800 is obtained may be set to another time interval.

The time interval for which the actual viewing history 800 or the viewing history information is obtained may be a period corresponding to recent days and recent weeks, with respect to the current time. For example, the viewing history information may include information about a viewing time, content, a genre, and a channel of content that the user has viewed in recent one week, recent two weeks, recent three weeks, or recent four weeks with respect to the current time.

Referring to FIG. 8, the actual viewing history 800 is illustrated. In FIG. 8, a first type of input which is an ‘input directly referring to a second content’ is denoted as ‘In1’, a second type of input which is an ‘input referring to a channel providing the second content’ is denoted as ‘In2’, and a third type of input which is an ‘input corresponding to a channel up key or a channel down key for selecting the second content’ is denoted as ‘In3’. In addition, a first weight applied to a first content may be denoted as ‘w1’, a second weight applied to content in the second content selected through the first type of input may be denoted as ‘w2’, a third weight applied to content in the second content selected through the second type of input may be denoted as ‘w3’, and a fourth weight applied to content in the second content selected through the third type of input may be denoted as ‘w4’.

For example, a weight value may be set as shown in FIGS. 10 to 13.

On Sunday, Sep. 30, 2018, the user turned on the display device 300 at 19:00 and viewed content output from the display device 300 for 2 hours from 19:00 to 21:00.

The user viewed content called ‘New World’ which is a movie provided through channel 74 by the first type of input In1 801 from 19:00 immediately after the display device 300 is turned on to 20:00. Then the user viewed following ‘SBS NEWS’ provided through channel 6 by the second type of input In2 802 ‘New World’ from 20:00 to 21:00. That is, in the first type of input In1 801, the user directly utters ‘New World’ by voice or text inputs directly ‘New World’ through the user interface 210. In response, the controller 220 may control the communicator 250 to receive data corresponding to ‘New World’ provided through channel 74. The controller 220 may control the display 230 to output audio/video data corresponding to ‘New World’.

In addition, in the second type of input 802, the user utters ‘channel 6’, ‘6’, ‘number 6’, or ‘SBS’ by voice or directly inputs text ‘6’ or ‘SBS’ through the user interface 21, to select channel 6. In response, the controller 220 may control the communicator 250 to receive data corresponding to ‘SBS NEWS’ provided through channel 6. The controller 220 may control the display 230 to output audio/video data corresponding to ‘SBS NEWS’.

Hereinafter, an example in which weight values shown in FIG. 12 are used as weight values applied to obtain the viewing history information will be described.

In an embodiment of the disclosure, the controller 220 may obtain the viewing history information by applying the second weight w2 to the actual viewing time of ‘New World” which is the content selected as the first type of input Int. Specifically, the controller 220 may obtain the viewing history information by multiplying a weight value corresponding to the actual viewing time.

For example, the controller 220 may obtain the viewing history information using the viewing time of the content ‘New World’ as the actual viewing time 1 hour*second weight w2=1*2=2 hours. The controller 220 may obtain the viewing history information using the viewing time of the content ‘SBS NEWS’ as the actual viewing time 1 hour*third weight w3=1*1.7=1.7 hours.

In addition, on Monday, Oct. 1, 2018, the user turned on the display device 300 at 19:00 and then viewed a movie Lala Land' selected through the second type of input In2 811 for 1 hour and 30 minutes from 19:00 to 20:30. The user turned off the display device 300 at 20:30. In addition, the user turned on the display device 300 at 22 o'clock, and then viewed contents ‘Talk Issues Say Current Events’ and ‘Human Documentary I like Human’ output from the display device 300 for 2 hours from 22:00 to 24:00.

The user viewed ‘Talk Issues Say Current Events’ which is a current event content provided through channel 11 by the third type of input In3 815 from 22:00 immediately after the display device 300 is turned on to 23:00. Then, after ‘Talk Issues Say Current Events’ ends, the user viewed the documentary content ‘Human Documentary I like Human’ which is provided through channel 11, without any user input.

The controller 220 may obtain the viewing history information by applying the third weight w3 to the actual viewing time of ‘Lala Land’ which is the content selected through the second type of input In2 811. For example, the controller 220 may obtain the viewing history information using the viewing time of the content ‘Lara Land’ as the actual viewing time*third weight w3=1.5 hours*1.7=2.55 hours. The controller 220 may obtain the viewing history information using the viewing time of the content ‘SBS NEWS’ as the actual viewing time 1 hour*third weight w3=1*1.7=1.7 hours.

In addition, the controller 220 may obtain the viewing history information by applying the fourth weight w4 to the actual viewing time of ‘Talk Issues Say Current Events’ which is the content selected through the third type of input In3 815. For example, the controller 220 may obtain the viewing history information using the viewing time of the content ‘Talk Issues Say Current Events’ as the actual viewing time*third weight w3=1 hour*1.3=1.3 hours. The controller 220 may obtain the viewing history information using the viewing time of ‘Human Documentary I like Human’ which is the content not corresponding to a selection of the user as the actual viewing time of 1 hour*first weight w1=1*1=1 hour.

In addition, the controller 220 may obtain the viewing history information by applying weights to the actual viewing history with respect to Wednesday, Oct. 10, 2018 and Thursday, Oct. 4, 2018, as described above.

As described above, in an embodiment of the disclosure, the viewing history information may be obtained by applying different weights based on a user input for selecting content. Accordingly, a viewing history of content that is aggressively wanted and viewed by the user may be considered prior to a viewing history of content that is not aggressively selected by the user, and thus a recommendation channel that further accords with the intention of the user may be selected and provided. Accordingly, the satisfaction of the user who is provided with the recommendation list may increase.

In addition, when a user input for selecting content is received, the controller 220 may determine which content corresponds to the received user input. Specifically, the controller 220 may allow content starting for a certain time before and after a time when the user input is received to correspond to the received user input. The user input corresponding to certain content will be described in detail with reference to FIG. 9 below.

FIG. 9 is a diagram illustrating an example user input entered for selecting content. 9, the viewing history on Monday, Oct. 1, 2018, of the actual viewing history shown in FIG. 8 is shown in detail. Thus, in FIGS. 8 and 9, the same reference numerals denote the same elements.

The controller 220 may determine a user input received for an offset time before and after a time when the content starts as the user input for selecting the content.

When content starting for an offset time before and after a time when the user input is received exists, the controller 220 may determine that the received user input is the user input for selecting the content.

When the selected content is being broadcasted with respect to a time when a second type of user input or a third type of user input for selecting the content is received, the controller 220 may determine that the received user input is the user input for selecting the content. For reference, because the first type of user input is an input directly referring to specific content, it is apparent that the user input is for selecting the specific content.

The offset time may be set to a specific value by the controller 220 or setting of the user. For example, the offset time may be set as 10 minutes or 5 minutes before or after a specific time. Alternatively, the offset time may be set to an optimized value based on the viewing history of the user.

Hereinafter, an example in which the above-described offset time is set to 10 minutes before and after the specific time will be described. Referring to FIG. 9, ‘Talk Issues Say Current Events’ which is content provided through channel 11 is content broadcast starting at 22:00 until 23:00. When the offset time is set to 10 minutes, the controller 220 may determine content starting within 10 minutes before and after the time when the user input is received as the content corresponding to the user input. When the user input is received within 10 minutes before and after the content starts, the controller 220 may determine that the received user input is the user input for selecting the content.

For example, when the display device 300 receives a third type of input 911 from the user at 21:52, the content ‘Talk Issues Say Current Events’ starts in a channel selected within 10 minutes with respect to a time when the third type of input 913 is received. In this case, the controller 220 may determine that the third type of input 911 received at 21:52 is a user input for selecting the content ‘Talk Issues Say Current Events’.

As another example, when the display device 300 receives a third type of input 913 from the user at 22:07, the content ‘Talk Issues Say Current Events’ starts in the channel selected within 10 minutes with respect to the time when the third type of input 913 is received. In this case, the controller 220 may determine that the third type of input 913 received at 22:07 is the user input for selecting the content ‘Talk Issues Say Current Events’.

As another example, when the display device 300 receives a third type of input 915 from the user at 22:30, the content ‘Talk Issues Say Current Events’ is being broadcasted in a channel selected at a time when the third type of input 915 is received. In this case, the controller 220 may determine that the third type of input 913 received at 22:07 is the user input for selecting the content ‘Talk Issues Say Current Events’.

In an embodiment of the disclosure, the controller 220 may update the weight values described above based on at least one of the satisfaction of the user or the viewing history of the user.

FIG. 11 is a diagram illustrating an example operation of updating a weight applied according to an embodiment of the disclosure.

A weight value shown in FIG. 10 is an initially set weight value and may be updated as shown in a table 1100 of FIG. 11. In addition, a weight value shown in FIG. 12 is an initially set weight value and may be updated as shown in a table 1300 of FIG.13.

The controller 220 may update the weight value based on the satisfaction of a user. After providing a recommendation list, the display device 300 may receive the satisfaction of the user with respect to the recommendation list. The controller 220 may change the weight value in a direction in which the satisfaction of the user increases.

As another example, the controller 220 may update the weight value based on an actual viewing history. The controller 220 may obtain the actual viewing history every certain time interval. For example, it is assumed that the controller 220 obtains the actual viewing history for one week and generates a favorite channel list based on viewing history information corresponding to the obtained actual viewing history. For example, the controller 220 has firstly generated the recommendation list based on the viewing history information collected for a first week of September 2018. After providing recommendation channels included in the firstly obtained recommendation list, the controller 220 may compare the recommendation channels with channels actually viewed by the user and update weight values used for obtaining the firstly generated recommendation list. Specifically, the controller 220 may update the weight values based on viewing history information collected in a second week of September 2018 with respect to the channels actually viewed by the user for the second week of September 2018. That is, the controller 220 may obtain the updated weight values by modifying the weight values such that the recommendation channels included in the recommendation list match the channels actually viewed by the user.

In an embodiment of the disclosure, the display device 300 may obtain the above-described weight values through a neural network. The neural network may perform information processing using artificial intelligence (AI). In addition, the neural network may be implemented to perform an intended operation through a processor including at least one instruction. In addition, unlike an existing rule-based smart system, an AI system is a system that trains itself autonomously and makes decisions. The more the AI system is used, the more the recognition rate of the AI system may improve and the AI system may more accurately understand a user preference, and thus, an existing rule-based smart system is being gradually replaced by a deep learning based AI system.

AI technology includes machine learning (deep learning) and element technologies that utilize the machine learning. Machine learning may refer, for example, to an algorithm technology that classifies/learns the features of input data autonomously. Element technology may refer, for example, to a technology that simulates the functions of the human brain such as recognition and judgment utilizing machine learning algorithm such as deep learning and may include technical fields such as linguistic understanding, visual comprehension, reasoning/prediction, knowledge representation, and motion control.

Hereinafter, the neural network used in an embodiment of the disclosure will be described in greater detail below with reference to FIGS. 14, 15, 16 and 17.

FIG. 14 is a diagram illustrating an example neural network used to obtain recommended channels according to an embodiment of the disclosure.

In an embodiment of the disclosure, operation according to the neural network may be performed through a processor (not shown) of the controller 220. The operation through the neural network for generating the above-described weight values and/or recommendation list may be performed by at least one processor included in the controller 220, a dedicated processor (not shown) in the display device 300, and an external device (not shown) or an external server (not shown).

The operation according to the neural network may be performed by the external server (not shown), and the display device 300 may receive results (e.g., the above-described weight values and/or recommendation list) of the operation according to the neural network from the external server (not shown).

Hereinafter, an example in which the operation according to the neural network is performed through the processor (not shown) of the controller 220 will be described.

In an embodiment of the disclosure, the neural network may be an AI network based on AI technology, and may train input data to obtain the above-described weight values. For example, the neural network may receive the above-described actual viewing history as the input data, train the received input data, and generate the above-described weight values as output data.

The neural network may train the input data to obtain the recommendation list. For example, the neural network may receive the actual viewing history as the input data and train the received input data to obtain the recommendation list based on viewing history information generated by generating the above-described weight values and applying the generated weight values. Alternatively, the neural network may train the viewing history information to generate the recommendation list.

FIG. 14 illustrates an example in which a recurrent neural network (RNN) 1400 is used as the neural network according to an embodiment of the disclosure. In addition, FIG. 14 illustrates the example of the neural network capable of receiving the viewing history information and outputting at least one recommendation channel included in the recommendation list.

The neural network used in an embodiment of the disclosure may include an input layer 1410 that receives the viewing history information obtained by applying at least one of a first weight or a weight applied to a second content, a hidden layer 1420 that performs an operation of generating at least one recommendation channel based on the viewing history information received by the input layer, and an output layer 1430 that outputs at least one recommendation channel.

Referring to FIG. 14, the RNN 1400 may be formed in a structure of the input layer 1410, the hidden layer 1420, and the output layer 1430.

Referring to FIG. 14, the input layer 1410 may receive a plurality of input data corresponding to an actual viewing history of a user. Each of the plurality of input data may include information corresponding to the actual viewing history of the user collected every certain time unit. The certain time unit may be 1 hour, 1 day (24 hours), etc. For example, In t1 may be data corresponding to the actual viewing history of the user on Sep. 30, 2018 of FIG. 8. Also, In t2 may be data corresponding to the actual viewing history of the user on Oct. 1, 2018 of FIG. 8. Also, In t3 may be data corresponding to the actual viewing history of the user on Oct. 2, 2018 of FIG. 8.

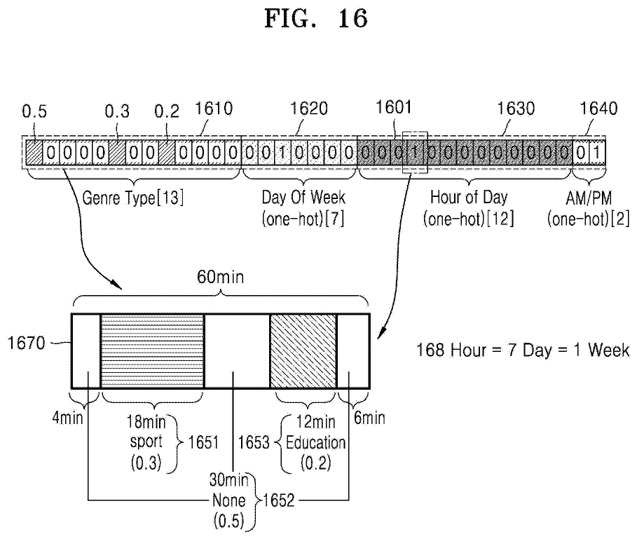

In the RNN 1400, the number of input nodes included in the input layer 1410 may vary according to the number of input data. For example, FIG. 14 illustrates the example in which three input nodes In t1, In t2, and In t3 are included in the input layer 1410. As another example, when data input to one input node is a viewing history collected for 24 hours, and the recommendation list is generated based on viewing history information collected for a week, seven input nodes may be included in the input layer 1410. The input data will be described in detail with reference to FIG. 16 below.

The hidden layer 1420 may analyze the input data and generate at least one of weight values and/or the recommendation list based on a result of analysis. The hidden layer 1420 may perform an operation through a plurality of operations or layers. Here, when the RNN 1400 performs the operation through the plurality of layers included in the hidden layer 1420, the RNN 1400 may be referred to as a deep neural network including a plurality of depths.

The output layer 1430 outputs a result of the operation performed through the hidden layer 1420. In an embodiment of the disclosure, the output layer 1430 may output the recommendation list.

In addition, the neural network used in an embodiment of the disclosure may include an input layer that receives the actual viewing history and information about a type of a user input corresponding to the actual viewing history, a hidden layer that calculates data received through the input layer, and an output layer that outputs at least one recommendation channel. Here, the hidden layer may include a plurality of layers each including a depth and may perform an operation for optimizing and setting weight values applied to the actual viewing history.

FIG. 15 is a diagram illustrating an example neural network used to obtain recommendation channels according to an embodiment of the disclosure.

In an embodiment of the disclosure, an operation for generating the above-described weight and/or recommendation list may be performed through a long short-term memory (LSTM) neural network 1500 which is a type of a RNN. FIG. 15 is a diagram for explaining the RNN. Thus, in FIGS. 14 and 15, the same reference numerals denote the same elements. Therefore, the redundant descriptions provided above in relation to FIG. 14 will not be repeated to describe the LSTM neural network 1500 shown in FIG. 15.

FIG. 15 illustrates an example of the neural network capable of outputting the recommendation list based on viewing history information obtained by applying a weight.

Referring to FIG. 15, data input to the input layer 1410 may be the viewing history information corresponding to the actual viewing history of the user. The data input to the input layer 1410 may include information about a viewing time of the user and content. The information about the content may include at least one of a channel corresponding to content viewed by the user, a name of the viewed content, or genre information of the viewed content.

Referring to FIG. 15, the input layer 1410 may receive viewing history information 1511 of the user of 7, which is 7 days, *24=168 hours. The viewing history information 1511 of the user of 7 days may be subdivided in a 1 hour interval.

Referring to FIG. 15, the viewing history information 1511 of 7 days may be expressed as a combination of viewing history information 1512 and 1513 in unit of 1 hour. That is, the 7*24=168 viewing history information 1512 of 1 hour may be combined to form the viewing history information 1511 of 7 days. For example, the viewing history information 1511 may be the viewing history information of the user for 7 days from Sep. 2, 2018 (Sunday) to Sep. 8, 2018 (Saturday), which is a second week of September of 2018.

The viewing history information 1512 included in a first column of the viewing history information 1511 may be information representing a viewing history during 0:00-1:00 of Sep. 2, 2018 (Sunday), and the viewing history information 1513 included in a last column of the viewing history information 1511 may be information representing a viewing history during 23:00-24:00 of Sep. 8, 2018 (Saturday). A detailed configuration of the viewing history information (e.g., 1512 or 1513) representing the viewing history of the user for 1 hour will be described in detail with reference to FIG. 16 below.

FIG. 16 is a diagram illustrating example input data input to a neural network shown in FIG. 15. Referring to FIG. 16, information 1601 may correspond to the viewing history information 1512 or 1513 for 1 hour.

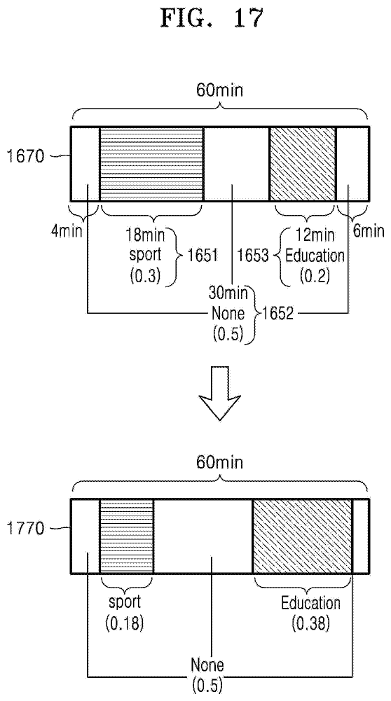

FIG. 16 illustrates information representing an actual viewing history of a user for 1 hour. FIG. 17 illustrates viewing history information obtained by applying a weight to an actual viewing history of a user for 1 hour.

Referring to FIG. 16, the information 1601 may include information about viewed content and information about a viewing time (information about at least one of a viewing time or day of week). The information 1601 may include information 1610 indicating a genre of the viewed content, viewing day of week information 1620, viewing hour of day information 1630, and information 1640 about whether the viewing time is AM or PM.

For example, the information 1601 representing the actual viewing history of the user for 1 day may be a combination of 34 unit data. One block included in the information 1601 may represent one unit data.

Here, each of blocks included in the information 1610 representing the genre of the viewed content may correspond to a certain genre. For example, the leftmost block to the rightmost block included in the information 1610 may respectively correspond to 1) no genre (or no viewing information), 2) drama, 3) movie, 4) animation, 5) entertainment, 6) sports, 7) hobby, 8) music, 9) education, 10) affair, 11) news, 12) documentary, and 13) shopping. That is, the leftmost block of the information 1610 may indicate no genre (or no viewing information), and a right sixth block of the information 1610 may correspond to sports.

In addition, the viewing day of week information 1620 may indicate information about which day of week among Monday, Tuesday, Wednesday, Thursday, Friday, Saturday and Sunday corresponds to a viewing day of week. For example, the leftmost first block of the viewing day of week information 1620 represents Monday, and the last block represents Sunday. In addition, the viewing hour of day information 1630 may be information indicating each viewing hour of day of 0 o'clock to 12 o'clock. For example, the leftmost first block of the viewing hour of day information 1630 may represent a hour of day from 0 o'clock to 1 o'clock, a second block may represent a hour of day from 1 o'clock to 2 o'clock, and the last block may represent a hour of day from 11 o'clock to 12 o'clock. In addition, the information 1640 about whether the viewing time is AM or PM may include a first block indicating AM and a second block indicating PM.

For example, the information 1601 is information representing an actual viewing history of the user on Wednesday, Sep. 5, 2018. Specifically, the user views at least one content output from the display device 300 for one hour between PM3:00 and PM4:00. Specifically, referring to information 1670, the user does not view the display device 300 for the first 4 minutes for 1 hour, views 1651 content corresponding to a sports genre on a sports channel for the following 18 minutes, and does not view the display device 300 for the following 30 minutes. Then, the user views 1653 content corresponding to an education genre on an education broadcast channel for the following 12 minutes. That is, the user does not view anything for 30 minutes (0.5 hours) for 1 hour between PM3:00 and PM4:00, view the content corresponding to the sports genre for 18 minutes (0.3 hours), and views content corresponding to an education genre for 12 minutes (0.2 minutes).

Each of the leftmost block to the rightmost block included in the information 1610 may respectively correspond to 1) no genre (or no viewing information), 2) drama, 3) movie, 4) animation, 5) entertainment. 6) sports, 7) hobby, 8) music, 9) education, 10) affair, 11) news, 12) documentary, and 13) shopping.

In the above example, a first block included in the information 1610 may represent ‘1) no genre (or no viewing information)’ and may have a value of 0.5 to correspond to the information 1670, a sixth block may represent a ‘6) sports’ genre and may have a value of 0.3 to correspond to the information 1670, and a ninth block may represent a ‘9) education’ genre and may have a value of 0.2 to correspond to the information 1670. In addition, the viewing day of week information 1620 may have a value of ‘1’ in a third block so as to indicate a viewing history of Wednesday. In addition, the viewing hour of day information 1630 may have a value of ‘1’ in a fourth block so as to correspond to a viewing history between PM3:00 and PM4:00. In addition, the information 1640 may have a value of ‘1’ in a second block so as to correspond to a viewing history in the afternoon time.

As described above, the viewing history information may be obtained by applying weight values to the actual viewing history. The viewing history information to which the weight values are applied will be described in detail with reference to FIG. 17 below.

FIG. 17 is a diagram illustrating example viewing history obtained in an embodiment of the disclosure. Thus, in FIGS. 16 and 17, the same reference numerals denote the same elements. Therefore, the redundant descriptions provided above in relation to FIGS. 16 and 17 will not be repeated.

For example, the second weight w2 applied to content selected through a first type of input which is an input directly referring to second content may have a value of 1.9. In addition, the first weight w1 applied to first content that does not correspond to a user input (specifically, content output to the display device 300 without the user input) may have a value of 0.6.

Referring to FIG. 17, a block 1670 represents an actual viewing history, and block 1770 represents viewing history information obtained by applying a weight. An embodiment of the disclosure obtains the viewing history information by applying weight values to the actual viewing history.

Content corresponding to a sports genre may not correspond to the user input, and content corresponding to an education genre may correspond to the first type of input among user inputs. That is, the user views the content corresponding to the sports genre without any selection for 18 minutes through the display device 300. The user inputs the first type of input directly referring to the content corresponding to the education genre to the display device 300 to view the content corresponding to the education genre for 12 minutes.

In this case, the controller 220 may apply a weight to the viewing time of the content of the sports genre that does not correspond to the user input to obtain a viewing time*w1=0.3 hours*0.6=0.18 hours as the viewing history information. In addition, the controller 220 may apply a weight to the viewing time of the content of the education genre corresponding to the first type of input to obtain a viewing time*w2=0.2 hours*1.9=0.38 hours as viewing history information.

Accordingly, the controller 220 may allow data values in the information 1610 to reflect a block 1770 illustrated in FIG. 17 such that the information 1601 illustrated in FIG. 16 corresponds to the viewing history information. That is, the controller 220 may allow data input to the input layer 1410 of the neural network to be viewing history information 1601 including the information 1610 corresponding to the block 1770. In this case, in the information 1610 included in the information 1601 input to the input layer 1410 of the neural network, values of 0.3 and 0.2 illustrated in FIG. 16 may respectively change to 0.12 and 0.38.

The LSTM neural network 1500 may receive the viewing history information 1511 of the user for 7 days through the input layer 1410. The viewing history information 1511 received through the input layer 1410 may be divided into viewing history information in units of 1 hour and may be input to t1 1522 to t168 1523 LSTM layers respectively corresponding to a total of 7 days*24 hours=168 hours.

The LSTM neural network 1500 is a neural network that solves the problem of long-term dependencies of a RNN and has a chain structure for performing an operation related to previous data for long-term dependency training. The LSTM layer 1523 forming the LSTM neural network 1500 has a structure in which a previous input is continuously transmitted to a subsequent step, and performs an operation in at least one layer forming the LSTM neural network 1500.

Specifically, the LSTM neural network 1500 may perform an operation through a dense layer 1525 in which data output through the LSTM layer 1523 are densely connected and based on the viewing history information of the user determine a channel or content having a high probability of being viewed by the user and output the channel or content to the output layer 1430. Here, the dense layer 1525 is a neural network in which connections between nodes of hidden layers forming a neural network are densely connected and may be referred to as a fully connected neural network. In FIG. 15, the hidden layers in the dense layer 1525 are not shown in detail. At least one hidden layer that is interconnected through a full connection may be formed in the dense layer 1525.

As described above, a method of providing a recommendation list according to an embodiment of the disclosure and a display device using the method may generate the recommendation list in consideration of whether a user input for selecting content exists, and thus a user may quickly and conveniently select a desired content. Accordingly, satisfaction of the user who receives the recommendation list may increase.

A method of generating a recommendation list, according to an embodiment of the disclosure, may be implemented in the form of program commands that can be executed through various computer means, and may be recorded in a computer-readable recording medium. An embodiment of the disclosure may be implemented in the form of a computer-readable recording medium having recorded thereon one or more programs including instructions for executing the above-described method.

The computer-readable recording medium may store program commands, data files, data structures, or combinations thereof. The program commands recorded on the computer-readable recording medium may be those specially designed and constructed for the purposes of the disclosure, or they may be of the kind well known and available to one of ordinary skill in the art of computer software. Examples of the computer-readable recording medium include magnetic media (e.g., hard disks, floppy disks, and magnetic tapes), optical media (e.g., CD-ROMs or DVDs), magneto-optical media (e.g., floptical disks), and hardware devices (e.g., ROMs, RAMs, or flash memories, etc.) that are specially configured to store and execute program commands. Examples of the program commands include both machine code, such as code made by a compiler, and high-level language code that may be executable by an interpreter.

The above-described method of generating the recommendation list, according to an embodiment of the disclosure, may be implemented in the form of a computer program product including a recording medium having recorded thereon a program configured to perform an operation of obtaining a multilingual sentence, and an operation of obtaining vector values respectively corresponding to words included in the multilingual sentence, using a multilingual translation model, converting the obtained vector values into vector values corresponding to a target language, and obtaining a sentence of the target language based on the converted vector values.

A method of providing a recommendation list according to an embodiment of the disclosure and a display device using the method may obtain a viewing history by applying a high weight to content that a user actively searches for and views, thereby generating the recommendation list that further accords with the intention of the user. Accordingly, satisfaction of the user may increase.

While various example embodiments of the disclosure have been illustrated and described with reference to the figures, it will be understood by one of ordinary skill in the art that various changes in form and details may be made therein without departing from the scope of the disclosure including the following claims.

What is claimed is:

1. A method, performed by a display device for outputting content, of providing a recommendation list, the method comprising:
generating viewing history information by applying a first weight to first content displayed without user input for content selection, the first weight having a value less than a value of a weight applied to second content, the second content being displayed based on a user input for content selection;
generating a recommendation list comprising at least one recommendation item based on the viewing history information; and
providing the recommendation list to a user.

2. The method of claim 1, further comprising setting a value of a weight applied to the second content differently based on a type of the user input for selecting the second content.

3. The method of claim 1, wherein the generating of the viewing history information comprises obtaining the viewing history information by applying a second weight to the second content based on the second content being selected through a first type of selection method, applying a third weight to the second content based on the second content being selected through a second type of selection method, and applying a fourth weight to the second content based on the second content being selected through a third type of selection method.

4. The method of claim 3, wherein the first type of selection method includes a selection method directly referring to the second content,
wherein the second type of selection method includes a selection method referring to a channel providing the second content, and
wherein the third type of selection method includes a selection method using a channel up key or a channel down key for selecting the second content.

5. The method of claim 1, further comprising obtaining the first weight and the weight applied to the second content through an operation using a neural network,
wherein the neural network is configured to: receive a viewing history of a plurality of content output through the display device during a first period and information about a user input for selecting the plurality of content during the first period, perform an operation using at least one layer of the neural network, and output a value of the first weight applied to the first content and a value of at least one weight applied to the second content.

6. The method of claim 5, wherein the information about the user input comprises a type of the user input for selecting content and time information corresponding to the user input.

7. The method of claim 1, wherein the generating of the viewing history information comprises obtaining the viewing history information based on metadata indicating an output schedule of the content output from a set top box based on the display device outputting content provided through the set top box.

8. The method of claim 1, wherein the providing comprises obtaining the at least one recommendation item by performing an operation using a neural network configured to receive the viewing history information obtained by applying at least one of the first weight or the weight applied to the second content.

9. The method of claim 1, further comprising transmitting the viewing history information to a server configured to provide a service customized for each user.

10. A display device comprising:
a display;
a user interface configured to receive a user input;
a memory storing one or more instructions; and
a controller comprising at least one processor configured to execute at least one of the one or more instructions,
wherein the controller is configured to, by executing at least one of the one or more instructions, to control the display device to:
generate viewing history information by applying a first weight to first content displayed without user input for content selection, the first weight having a value less than a value of a weight applied to a second content, the second content being displayed based on a user input for content selection;
generate a recommendation list comprising at least one recommendation item based on the viewing history information; and
display a screen comprising the recommendation list.

11. The display device of claim 10, wherein the controller is further configured to control the display device to set a value of a weight applied to the second content differently based on a type of user input for selecting the second content.

12. The display device of claim 10, wherein the controller is further configured to control the display device to obtain the viewing history information by applying a second weight to the second content based on the second content being selected through a first type of selection method, applying a third weight to the second content based on the second content being selected through a second type of selection method, and applying a fourth weight to the second content based on the second content being selected through a third type of selection method.

13. The display device of claim 12, wherein the first type of selection method includes a selection method directly referring to the second content,
wherein the second type of selection method includes a selection method referring to a channel providing the second content, and
wherein the third type of selection method includes a selection method using a channel up key or a channel down key for selecting the second content.

14. The display device of claim 10, wherein the controller is further configured to control the display device to obtain the first weight and the weight applied to the second content through an operation using a neural network, and
wherein the neural network is configured to: receive a viewing history of a plurality of content output through the display device during a first period and information about a user input for selecting the plurality of content during the first period, perform an operation using at least one layer of the neural network, and output a value of the first weight applied to the first content and a value of at least one weight applied to the second content.

15. The display device of claim 10, wherein the controller is further configured to control the display device to obtain the at least one recommendation item by performing an operation using a neural network configured to receive the viewing history information obtained by applying at least one of the first weight or the weight applied to the second content.

16. The display device of claim 10, wherein the at least one processor included in the controller is configured to perform an operation using a neural network,
wherein the neural network comprises an input layer configured to receive the viewing history information obtained by applying at least one of the first weight or the weight applied to the second content, a hidden layer configured to perform an operation of generating at least one recommendation channel based on the viewing history information received by the input layer, and an output layer configured to output the at least one recommendation channel.

17. The display device of claim 10, further comprising an communicator comprising communication circuitry configured to communicate with an external server,
wherein the controller is further configured to control the communicator to transmit the viewing history information to a server providing a service customized for each user.
